(19) United States
(12) Patent Application Publication
(10) Pub. No.: US 2026/0223186 A1
(43) Pub. Date: Jul. 30, 2026

(54) SIGNALLING FOR WIRELESS COMMUNICATION

(71) Applicant: Telefonaktiebolaget LM Ericsson (publ), Stockholm (SE)

(72) Inventors: Stefan PARKVALL, Bromma (SE); Robert BALDEMAIR, Solna (SE); Erik ERIKSSON, Linkoping (SE)

(21) Appl. No.: 19/146,452

(22) PCT Filed: Jan. 9, 2023
(86) PCT No.: PCT/SE2023/050012

§ 371 Date: Jul. 8, 2025

(51) Int. Cl. H04W 74/0833

(52) U.S. Cl. CPC H04W 74/0833

(57) ABSTRACT

There is disclosed a method of operating a receiving radio node (10) in a radio access network, the method comprising communicating based on received random access response, the random access response having multiple symbol contents, the random access response having a signalling structure in which for each symbol content, the symbol content is repeated sequentially NO-times, wherein NO is an integer of 2 or larger. The disclosure also pertains to related devices and methods.

### TECHNICAL FIELD

This disclosure pertains to wireless communication, in particular for high frequencies.

### BACKGROUND

For future wireless communication systems, it is likely that different frequency ranges and/or high frequency ranges are being used for transmission of data. Also, different TRPs (Transmission/Reception Points) may be utilised. In particular for high frequencies, the channel conditions, in particular for timing (e.g., path delay) and/or pathloss (power loss), may be quite different for even relatively small differences in frequency and/or for differently located TRPs. Moreover, high frequencies tend to be used with short timescales for symbols and prefixes; path delay effects may be significantly larger than the prefix times, which may affect timing of processing of signalling in particular in OFDM-based systems.

### SUMMARY

It is an object of this disclosure to provide approaches for improved signalling for wireless communication, in particular for random access. The approaches described may be utilised for one or more different frequencies ranges. For example, they may be implemented for frequency ranges (e.g., carrier bandwidth and/or system bandwidth) for communication signalling of 1 GHz or more, 2 GHz or more, 5 GHz or more, or 6 GHz or more, or 10 GHz or more, and/or for millimeter wave communication, in particular for radio carrier frequencies around and/or above 52.6 GHz, which may be considered high radio frequencies (high frequency) and/or millimetre waves. The carrier frequency/ies may be between 52.6 and 140 GHz, e.g. with a lower border between 52.6, 55, 60, 71 GHz and/or a higher border between 71, 72, 90, 114, 140 GHz or higher, in particular between 55 and 90 GHz, or between 60 and 72 GHz; however, higher frequencies may be considered, in particular frequency of 71 GHz or 72 GHz or above, and/or 100 GHz or above, and/or 140 GHz or above. The carrier frequency may in particular refer to a center frequency or maximum frequency of the carrier. The radio nodes and/or network described herein may operate in wide-band, e.g. with a carrier bandwidth (or bandwidth or carrier aggregation) of 400 MHz or more, in particular 1 GHz or more, or 2 GHz or more, or even larger, e.g. 6 GHz or more, or 8 GHz or more; the scheduled or allocated bandwidth may be the carrier bandwidth, or be smaller, e.g. depending on channel and/or procedure. In some cases, operation may be based on an OFDM wave-form or a SC-FDM wave-form (e.g., downlink and/or uplink), in particular a FDF-SC-FDM-based wave-form. However, operation based on a single carrier wave-form, e.g. SC-FDE (which may be pulse-shaped or Frequency Domain Filtered, e.g. based on modulation scheme and/or MCS), may be considered for downlink and/or uplink. In general, different wave-forms may be used for different communication directions. Communicating using or utilising a carrier and/or beam may correspond to operating using or utilising the carrier and/or beam, and/or may comprise transmitting on the carrier and/or beam and/or receiving on the carrier and/or beam. Operation may be based on and/or associated to a numerology, which may indicate a subcarrier spacing and/or duration of an allocation unit and/or an equivalent thereof, e.g., in comparison to an OFDM based system. A subcarrier spacing or equivalent frequency interval may for example correspond to 960 kHz, or 1920 kHz, e.g. representing the bandwidth of a subcarrier or equivalent.

The approaches are particularly advantageously implemented in a future 6th Generation (6G) telecommunication network or 6G radio access technology or network (RAT/RAN), in particular according to 3GPP (3rd Generation Partnership Project, a standardisation organization). A suitable RAN may in particular be a RAN according to NR, for example release 18 or later, or LTE Evolution. However, the approaches may also be used with other RAT, for example future 5.5G systems or IEEE based systems.

There is disclosed a (first) method of operating a receiving radio node in a radio access network. The method comprises communicating based on received first signalling, the first signalling comprising a preamble part and a message part.

A (first) receiving radio node for a radio access network is proposed. The receiving radio node is adapted for communicating based on received first signalling, the first signalling comprising a preamble part and a message part.

Moreover, a (first) method of operating a transmitting radio node in a radio access network is considered. The method comprises transmitting first signalling, the first signalling comprising a preamble part and a message part.

Also, a (first) transmitting radio node for a radio access network is described. The transmitting radio node is adapted for transmitting first signalling, the first signalling comprising a preamble part and a message part.

There may in general be considered a (second) method of operating a receiving radio node in a radio access network. The method comprises receiving first signalling, the first signalling representing a random access response, the random access response being represented by a separate control information message. A (second) receiving radio node for a radio access network may be considered. The receiving radio node is adapted for receiving first signalling, the first signalling representing a random access response, the random access response being represented by a separate control information message. A (second) method of operating a transmitting radio node in a radio access network is described. The method comprises transmitting first signalling to a receiving radio node, the first signalling representing a random access response, the random access response being represented by a separate control information message. Moreover, a (second) transmitting radio node for a radio access network is disclosed. The transmitting radio node is adapted for transmitting first signalling to a receiving radio node, the first signalling representing a random access response, the random access response being represented by a separate control information message. In general, the second methods and devices may be implemented as one of the methods and devices described herein. Thus, the second methods may comprise one or more features of other methods described, and/or second devices may comprise one or more features of other devices described herein. The random access response may be associated to, and/or transmitted on, and/or be on a physical control channel, e.g. a Physical Downlink Control CHannel, PDCCH. It may be considered that the separate control information message is not indicating reception of another message to the receiving radio node, and/or not indicating a data channel transmission, e.g. of a MsgB or Msg2. The separate control information message may schedule a transmission by the receiving radio node. The random access response may have a repetitive time domain structure.

Receiving first signalling may in general comprise receiving, and/or monitoring for, the first signalling, and/or determining a timing based on the first signalling, in particular based on a preamble part and/or preamble, and/or based on a multi-symbol repetitive structure of the first signalling, or of a part thereof. A preamble part may comprise and/or represent and/or correspond to a preamble; it may also comprise a time gap and/or pilot signalling. Communicating based on received first signalling may comprise determining and/or adjusting and/or setting a (second) timing, for example for reception, e.g. of further signalling, and/or of a part of the first signalling, e.g. a message part or message content, e.g. control information or signalling on a data channel. Alternatively, or additionally, it may comprise adjusting and/or determining and/or setting a (third) timing for transmission, e.g. in response to the received first signalling, and/or based on scheduling information, which may be provided by the first signalling. Communicating based on received first signalling additionally, or alternatively, may comprise receiving signalling, e.g. first signalling, and/or further signalling, e.g. based on the timing, and/or may comprise transmitting signalling, e.g. based on and/or according to the associated timing. A message part may comprise one or more messages, which may be on the same or different channels like physical layer channels and/or transport or logical channels, and/or a control channel like PDCCH or PSCCH, and/or a data channel, e.g. a PDSCH or PSSCH. It may be considered that the preamble part has a different numerology than the message part, e.g. a longer symbol time interval duration and/or longer cyclic prefix duration. A first timing may be used for reception of the first signalling, and/or of a preamble part, and/or to determine a (second) timing for reception and/or a (third) timing for transmission. A first FFT window timing may be associated to the first timing, a second FFT window timing may be associated to the second timing; the FFT windows may be used for FFT processing of signalling.

Accordingly, shifts in timing, e.g. due to different transmitters/TRPs being involved and/or scenarios with potential path delays much longer than a cyclic prefix duration may be accommodated, e.g. in system with high numerologies and/or short symbol timescales.

It may be considered that the preamble part may comprise reference signalling. The reference signalling may be synchronisation signalling, e.g. sync CSI-RS (in the form of CSI-RS). Thus, a known waveform may be used; however, newly designed signalling, or other known signalling may be used as well, e.g. a variant of PSS and/or SSS, or DM-RS.

It may be considered that the preamble part may cover an/or be carried on a plurality of allocation units, e.g. a plurality of block symbols and/or symbol time intervals. In particular, it may cover and/or be carried on two allocation units. This allows a cyclic shifted signal or symbol content being used, e.g. facilitating timing determination.

In some cases, a preamble part may be based on a sequence root and/or represent a predefined sequence. The root or sequence may be selected from a set of roots, and/or sequences, which may be predefined, e.g. in a standard. The selection may be indicated to the receiving radio node based on system information signalling and/or control signalling, e.g. by the transmitting radio node. This allows efficient signalling with low overhead, and/or unambiguous use, and/or efficient processing, of the root or sequence.

Different parts of the preamble part, e.g. parts associated to different allocation units, may be shifted relative to each other, and/or be based on the same sequence root and/or sequence. The shift may be a cyclic shift, and/or the different parts shifted may be represent cyclic extensions of each other; this may include one or more prefixes, which may cyclically extend to a leading symbol tail, and a trailing symbol or symbol content. Two or more parts of the preamble, e.g. on neighbouring and/or bordering symbols, may represent a cyclically extended and/or repeated sequence, which may be based on a (shorter in number of elements) sequence, which may be repeated at least in part. The shift may be a cyclic shift and/or be based on a phase ramping, e.g. with a linear ramping.

It may be considered that the message part may represent and/or comprise a random access response, and/or a data channel message and/or control channel message, e.g. a scheduling assignment scheduling a data channel message. The random access response may be a MsgB or Msg2. Thus, the approach may be utilised in a random access procedure, e.g. if a change of carrier or TRP is used.

The first signalling in general may be preceded by pilot signalling, e.g. an AGC pilot. This may facilitate training of circuitry for reception and/or to adapt to power changes.

It may be considered that the message part may comprise and/or consist of one or more messages. The messages may be associated to each other, e.g. representing a scheduling assignment scheduling another message or messages, which may be considered part of the message part.

The first signalling may be indicated and/or configured by configuration signalling, in particular broadcast signalling and/or synchronisation signalling and/or system information signalling. This signalling may be SSB signalling, and/or carried on a SSB beam. The configuration signalling may in general indicate a MsgB configuration and/or preamble configuration. The configuration signalling may indicate that different TRPs and/or transmitters and/or TRPs may be used to transmit synchronisation signalling and/or system information signalling, and the first signalling.

A (third) method of operating a receiving radio node in a radio access network is described. The method comprises communicating based on received first signalling, the first signalling comprising one or more messages, wherein one or more of the messages have a repetitive time domain structure.

A (third) receiving radio node for a radio access network is proposed. The receiving radio node is adapted for communicating based on received first signalling, the first signalling comprising one or more messages, wherein one or more of the messages have a repetitive time domain structure.

There is discussed a (third) method of operating a transmitting radio node in a radio access network. The method comprises transmitting first signalling, the first signalling comprising one or more messages, wherein one or more of the messages have a repetitive time domain structure.

Moreover, a (third) transmitting radio node for a radio access network is disclosed. The transmitting radio node is adapted for transmitting first signalling, the first signalling comprising one or more messages, wherein one or more of the messages have a repetitive time domain structure.

In general, the third methods and devices may be implemented as one of the methods and devices described herein. Thus, the third methods may comprise one or more features of other methods described, and/or third devices may comprise one or more features of other devices described herein.

A message part, and/or one or more messages, may comprise a random access response and/or data channel message and/or a control channel message. The messages may be associated to each other, e.g. representing a scheduling assignment scheduling another message or messages, which may be considered part of the message part. In this case, the scheduling assignment may not necessarily be a separate control information message.

A number of repetitions may indicate a number of occurrences, e.g. of a symbol content or signalling. Thus, one repetition may indicate only one occurrence, two repetitions may indicate two occurrences, etc. A repetitive time domain structure may indicate that (symbol) content of at least one allocation unit or symbol is repeated at least twice, e.g. on neighbouring or bordering allocation units or symbols. The repetition may in general be based on a shift of content, e.g. cyclically shifting and/or linear ramping.

The repetitive time domain structure may comprise repetition of signalling carried on at least one allocation unit (its content), in particular one block symbol and/or symbol time interval. It may comprise repetition of content of more than one allocation unit, e.g. of each contents of a PDCCH and/or PDSCH or each content of a message may be repeated at least twice.

It may be considered that the repetitive time domain structure may comprise only one repetition of signalling carried on each allocation unit of at least one message (its content), in particular each block symbol and/or symbol time interval of the at least one message. The message may be one of a plurality of messages. In particular, a data channel message, e.g. of a MsgB. Thus, signalling overhead is limited.

The message may be a MsgB, e.g. in a random access procedure.

The one or more messages may comprise a control channel message and a data channel message, wherein different repetitive time domain structures may be associated to different messages. For example, the control channel message (e.g., on PDCCH and/or a scheduling assignment scheduling the data channel message) may have two or more repetitions, whereas the repetitions of the data channel may be lower, e.g. it may be 1, or lower by one than the repetition of the control channel message. Each message in general may cover and/or be carried on one or more allocation units.

There is also considered a (fourth) method of operating a receiving radio node in a radio access network. The method comprises transmitting signalling based on a transmission timing, the transmission timing being based on a signalling characteristic of received first signalling.

A (fourth) receiving radio node for a radio access network is disclosed. The receiving radio node is adapted for transmitting signalling based on a transmission timing, the transmission timing being based on a signalling characteristic of received first signalling.

A (fourth) method of operating a transmitting radio node in a radio access network is proposed. The method comprises transmitting system information signalling and/or first signalling. The first signalling may have a signalling characteristic, and/or the system information signalling may indicate a signalling characteristic of first signalling.

Moreover, a (fourth) transmitting radio node for a radio access network is considered. The transmitting radio node is adapted for transmitting system information signalling and/or first signalling. The first signalling may have a signalling characteristic, and/or the system information signalling may indicate a signalling characteristic of first signalling.

In general, the fourth methods and devices may be implemented as one of the methods and devices described herein. Thus, the fourth methods may comprise one or more features of other methods described, and/or fourth devices may comprise one or more features of other devices described herein.

A signalling characteristic may indicate and/or represent a format, and/or time domain structure, and/or repetitive structure, and/or the presence or absence, or format, of a preamble part and/or pilot signalling and/or a message part or data channel message, and/or allocation information for transmission or reception of first signalling, e.g. time and/or frequency resources. The transmission timing may indicate the timing used for transmission to the transmitting radio node, and/or for uplink transmission, and/or to a second transmitter; it may be advanced relative to a reception timing to allow for path delay to the transmitting radio node.

It may be considered that a timing advance indication included in the first signalling is omitted, or the first signalling does not comprise a timing advance indication. This may be based on configuration signalling. A timing advance indication may be ignored or overwritten, e.g as it may be obsolete due to change of TRP or carrier. In some cases, a timing advance indication may be basis of determining a transmission timing, e.g. by adjusting the timing for transmission considering additional information.

The transmission timing may further be based on configuration signalling and/or system information signalling received. The signalling may indicate that another TRP than for system information signalling is used for first signalling and/or as target for the transmission of the receiving radio node. Additionally, or alternatively, an assumption of a maximum timing difference may be made and/or indicated with the system information signalling or configuration signalling, which may be transmitted by the transmitting radio node and/or a first transmitter. The timing difference may be based on and/or represented by and/or indicative of a spatial location shift or distance between a first transmitter and a second transmitter.

System information signalling or configuration signalling may indicate that the transmission timing is based on a signalling characteristic of the first signalling and/or on a content of the first signalling.

The signalling characteristic may pertain to a preamble part and/or a repetitive time domain structure of the first signalling. The signalling characteristic may comprise one or more characteristics. It may represent one or more of presence, timing, FFT window location and/or time and/or frequency resources and/or format and/or content.

System information signalling may in general indicate content and/or signalling characteristic/s of the first signalling.

A (fifth) method of operating a receiving radio node in a radio access network is considered. The method comprises communicating based on received pilot signalling, the pilot signalling being associated to first signalling.

There is also disclosed a (fifth) receiving radio node for a radio access network. The receiving radio node is adapted for communicating based on received pilot signalling, the pilot signalling being associated to first signalling.

A (fifth) method of operating a transmitting radio node in a radio access network is described. The method comprises transmitting pilot signalling and first signalling, the pilot signalling being associated to the first signalling.

Furthermore, a (fifth) transmitting radio node for a radio access network is proposed. The transmitting radio node is adapted for transmitting pilot signalling and first signalling, the pilot signalling being associated to the first signalling.

In general, the fifth methods and devices may be implemented as one of the methods and devices described herein. Thus, the fifth methods may comprise one or more features of other methods described, and/or fifth devices may comprise one or more features of other devices described herein. Pilot signalling being associated to first signalling may comprise and/or represent the pilot signalling leading the first signalling in time (for example, leading in time such that there is a maximum time interval between the end of the pilot signalling and the beginning of the first signalling), e.g. a maximum of a slot, or 10 allocation units, or 5 allocation units. Alternatively, or additionally, it may refer to indicating a power level of the first signalling, and/or allowing setting or tuning of reception circuitry for reception of the first signalling, and/or being indicated to be transmitted with signalling also indicating transmission of the first signalling.

The pilot signalling may pertain to Automatic Gain Control and/or power control. This may allow setting or tuning circuitry even if different power levels are used, e.g. due to quickly changing conditions, and/or due to different transmitters being used for first signalling and earlier signalling, e.g. system information signalling.

A power level of the pilot signalling may be indicated to the receiving radio node, e.g. with system information signalling (e.g., broadcast) or configuration signalling, or with the pilot signalling itself, e.g. encoded or represented therein.

It may be considered that the first signalling may be received based on the pilot signalling. For example, a gain for reception may be based on the pilot signalling. The pilot signalling may represent and/or comprise a training sequence for the receiving radio node, e.g. for its radio circuitry and/or receiver and/or transceiver. In general, the pilot signalling may be based on, and/or represent a signalling sequence, e.g. based on a sequence root.

It may be considered that the first signalling and the pilot signalling are transmitted by the same transmitter, e.g. out of a plurality of transmitters available for the transmitting radio node. This may ensure reliable training or gain control based on the pilot signalling

Between the pilot signalling and the first signalling there may be a time domain gap. The gap may be empty of signalling to be received by the receiving radio node, at least on the carrier of the pilot signalling and/or the first signalling. In general, the pilot signalling and the first signalling may be transmitted on the same carrier, and/or on completely, or at least partly, overlapping frequency resources.

The pilot signalling may have a comb structure in frequency domain. The comb may allow optimised resource use.

The pilot signalling may be indicated with system information signalling.

A (sixth) method of operating a receiving radio node in a radio access network is considered. The method comprises communicating based on a received random access response, the random access response having multiple symbol contents, the random access response having a signalling structure in which for each symbol content, the symbol content is repeated sequentially NO-times, wherein NO is an integer of 2 or larger.

A (sixth) receiving radio node for a radio access network is also described. The receiving radio node is adapted for communicating based on a received random access response, the random access response having multiple symbol contents, the random access response having a signalling structure in which for each symbol content, the symbol content is repeated sequentially NO-times, wherein NO is an integer of 2 or larger.

Moreover, a (sixth) method of operating a transmitting radio node in radio access network is proposed. The method comprises transmitting a random access response, the random access response having multiple symbol contents, the random access response having a signalling structure in which for each symbol content, the symbol content is repeated sequentially NO-times, wherein NO is an integer of 2 or larger.

A (sixth) transmitting radio node for a radio access network is disclosed. The transmitting radio node is adapted for transmitting a random access response, the random access response having multiple symbol contents, the random access response having a signalling structure in which for each symbol content, the symbol content is repeated sequentially NO-times, wherein NO is an integer of 2 or larger.

In general, the sixth methods and devices may be implemented as one of the methods and devices described herein. Thus, the sixth methods may comprise one or more features of other methods described, and/or sixth devices may comprise one or more features of other devices described herein. Symbol content being repeated sequentially may correspond to a repetitive time domain structure as described herein. It may be considered that the symbol content is the content of one message of the random access response, e.g. of a scheduling assignment or a control information message, e.g. a PDCCH. The random access response may correspond to a MsgB or Msg2. It may be considered that the random access response may correspond to first signalling.

In the signalling structure, a cyclic prefix may precede each repetition sequence of the symbol content. Repetitions in the sequence after the first may be without cyclic prefix.

The receiving radio node may be adapted to operate according to a transmission timing structure, wherein in the signalling structure, at least one repetition of the symbol content is not aligned with the transmission timing structure. The transmission timing structure may correspond to a timing or structure corresponding to system information signalling received.

NO may in particular be 2 or 3.

A symbol content being repeated NO times may refer to the symbol content being transmitted NO times. Sequential repetition may refer to each occurrence being neighbouring in time by at least one other occurrence, e.g., to form a chain or sequence of neighbouring occurrences of the symbol content; it may be considered that there is no other signalling interspersed into the NO repetitions. A symbol content may pertain to the signalling carried as information and/or content in time interval, e.g. corresponding to a symbol time interval. A cyclic prefix may correspond to part-repetition of the symbol content, e.g. representing the trailing end of a symbol content. The symbol content may pertain to physical characteristics of the signalling, e.g. regarding frequency and/or modulation and/or waveform and/or signal form. Different symbol contents (content repeated in different sequences) may be different. In some cases, it may be the same, e.g. if parts of a preamble are repeated. Thus, repetition may refer to the same modulation symbols being transmitted for each repetition, or cyclically shifted symbols or contents. A symbol content may generally refer to signalling without cyclic prefix. A symbol content may also be referred to as symbol proper, as opposed to a cyclic prefix. A signalling structure may prescribe a time domain arrangement of signalling and/or symbol content and/or cyclic prefixes, e.g. an order in time and/or respective duration(s). In general, the NO sequential repetitions of one symbol content may be referred to as repetition sequence. If there are NC symbol contents, there may be NC repetition sequences. Occurrences or repetitions of the same content may be shifted relative to each other, e.g. cyclically shifted. The symbol contents may be symbol contents of one message of a random access response, e.g. a control information message. A different message of the random access response, if present, may have a different NO, e.g. a smaller NO, and/or NO=1.

Communicating based on a random access response may comprise and/or correspond to communicating based on first signalling.

In the signalling structure, a cyclic prefix may precede each repetition sequence of the symbol content. Different sequences may have different cyclic prefixes. In general, the cyclic prefix may be adapted, e.g. in terms of duration, to align a repetition sequence plus the cyclic prefix to a transmission timing structure, e.g. such that the beginning of the cyclic prefix and the end of the repetition sequence (the end of the last symbol content repetition) may align with a symbol border, e.g. of an uplink transmission timing structure, e.g. an uplink frame structure. This may lead to the same durations for NO symbols according to the timing structure and the NO repetitions plus cyclic prefix; whether actual alignment happens may depend on path delays, at least before a timing advance has been signalled to, or determined by, the radio node.

The receiving radio node may in general be adapted to operate according to a transmission timing structure, e.g. a frame structure and/or based on a numerology. A transmitting radio node like a network node may be adapted for indicating the frame structure and/or numerology, e.g. with system information signalling and/or broadcast signalling like SSB signalling and/or signalling of system information; a wireless device may be adapted to receive such broadcast signalling and/or system information. In the signalling structure, at least one repetition of the symbol content may be not aligned with the transmission timing structure, and/or the duration associated to symbol content may be shorter than a symbol time interval according to the transmission timing structure (which may include a cyclic prefix of the transmission timing structure).

In general, symbol contents may comprise a preamble. Accordingly, one or more repetition sequences may represent a preamble, or parts thereof. A preamble may in general pertain to, and/or represent and/or comprise a sequence of signals or modulation symbols used for random access, with no higher layer coding. A preamble may be from a set of (pseudo-) orthogonal sequences, from which it may be selected randomly, or it may be specifically configured to a wireless device, e.g. after successfully establishing a network connection. The set, or a subset thereof, may be available for all wireless devices, and/or be predefined by a standard. A preamble may be non-encoded (e.g., no error coding) and/or have different modulation than symbols comprising and/or carrying and/or representing encoded information.

It may be considered that the symbol contents may comprise and/or carry and/or represent encoded information. Encoded information may be specific to a wireless device, e.g. indicating identity and/or one or more operation parameters; encoded information may comprise error coding, in particular error detection coding and/or error correction coding. This may be in addition to a preamble, or in lieu thereof. Symbol content representing and/or carrying and/or comprising encoded information may have a modulation different from the used for preamble/s, and/or may be associated to, and/or similar to, a transmission on a data channel like PDSCH.

In general, different symbol contents may be different. There is suggested internally repeating individual parts of the message (represented by symbol contents) instead and/or in addition to repeating the message as a whole. This allows processing with low latency and may optimise resource use.

It may be considered that symbol contents are sequential in time. Thus, a sequence or repetition sequences may be provided, e.g. without time intervals interspersed that do not represent part of the sequence, and/or time intervals larger than a cyclic prefix time (e.g., according to the signalling structure and/or the numerology and/or transmission timing structure) not part of the sequence interspersed, e.g. allowing for some guard intervals.

The symbol contents may comprise, and/or at least one symbol content may comprise, reference signalling, e.g. Demodulation Reference Signalling, DM-RS.

Each symbol content repetition may be carried on one allocation unit, e.g. a block symbol or symbol time interval.

At least one symbol content may comprise Demodulation Reference Signalling, DM-RS, and also may comprise control information, in particular encoded control information. This may correspond to a symbol time interval or allocation unit carrying both DM-RS and control information of a PDCCH transmission.

At least one symbol content may comprise Demodulation Reference Signalling on a comb in frequency domain.

A (seventh) method of operating a receiving radio node in a radio access network is considered. The method comprises receiving, from a first transmitter, synchronisation signalling and/or system information signalling; transmitting a random access message based on the synchronisation signalling and/or system information signalling; and receiving, from a second transmitter, a random access response.

A (seventh) receiving radio node for a radio access network is proposed. The receiving radio node is adapted for receiving, from a first transmitter, synchronisation signalling and/or system information signalling; transmitting a random access message based on the synchronisation signalling and/or system information signalling; and receiving, from a second transmitter, a random access response.

Moreover, a (seventh) method of operating a transmitting radio node in a radio access network is described. The method comprises transmitting, utilising a first transmitter, synchronisation signalling and/or system information signalling; receiving, from a receiving radio node, a random access message; and transmitting, utilising a second transmitter, a random access response in response to the random access message.

A (seventh) transmitting radio node for a radio access network is disclosed. The transmitting radio node is adapted for transmitting, utilising a first transmitter, synchronisation signalling and/or system information signalling; receiving, from a receiving radio node, a random access message; and transmitting, utilising a second transmitter, a random access response in response to the random access message.

In general, the seventh methods and devices may be implemented as one of the methods and devices described herein. Thus, the seventh methods may comprise one or more features of other methods described, and/or seventh devices may comprise one or more features of other devices described herein. Generally, the transmitting radio node may be adapted to control the first transmitter and/or the second transmitter, and/or may be implemented as the first transmitter or the second transmitter. The transmitting radio node may in general schedule and/or allocate resources for transmission and/or reception for the first transmitter and the second transmitter, and/or may schedule specific transmissions for the transmitters, e.g. of first signalling and system information signalling. The random access message may be in response to, and/or based on, the system information signalling and/or synchronisation signalling. It may be considered that the random access response is a form of first signalling, e.g. a MsgB.

The first transmitter may correspond to a first Transmission Reception Point, and/or the second transmitter corresponds to a second Transmission Reception Point.

A transfer indication indicating a change of transmitters may be included in the synchronisation signalling and/or system information signalling. This may indicate implicitly or explicitly the use of different transmitters, and/or may correspond to configuration signalling and/or may indicate a MsgB configuration and/or preamble configuration.

The random access response may be transmitted with a narrower beam angle than the synchronisation signalling and/or system information signalling. Thus, the response may utilise a higher beam forming gain, and/or reduce potential interference for other receivers.

The random access response may comprises one or more messages, e.g. on a control channel and/or a data channel, for example as a MsgB.

The random access response may comprise a preamble part and a message part, and/or the random access response may comprise one or more messages with repetitive time domain structure.

The second transmitter may be operated based on a wake-up signal and/or information provided by the transmitting radio node and/or first transmitter.

Approaches described herein facilitate accommodation of different channel conditions in particular for high frequency networks, e.g. due to changes in timing and/or power level, which may occur in particular when switching between TRPs, or between carriers or beams. Also, rapid changes may occur due to the sensitivity of high frequency signalling to timing effects. The use of multiple TRPS may optimise power and/or resource use, and/or limit interference, and/or offload systems used for transmitting synchronisation signalling.

A radio node, e.g. a transmitting or signalling radio node, and/or a receiving or feedback radio node, may operate in TDD mode, e.g. switching between DL periods and UL periods. A DL period may be a period in which the radio node operates using DL transmissions, an UL period may be a period in which the radio node operates using UL transmissions (e.g., a network node may transmit during DL, and receive during UL, and vice versa for a wireless device). It may be considered that there is a TDD guard period between DL and UL periods and/or between UL and DL periods, which may comprise a number of symbol time intervals, e.g. 10 or more symbols, or 12 or more symbols; there may be the same duration for guard periods for DL/UL and UL/DL, or different ones. The guard period may allow switching circuitry between the different communication directions and/or handling of interference (in particular considering that DL signalling tends to much more powerful than (received) UL signalling). An antenna arrangement may comprise one or more antenna elements and/or sub-arrays and/or panels; different antenna arrangements may comprise different antenna elements and/or sub-arrays and/or panels. Different antenna arrangements and/or panels and/or sub-arrays and/or elements may be adapted to be controlled or controllable separately from each other. There may be the same number of DL and UL periods and/or the same duration associated to DL and UL (at least over a certain time interval, e.g. alternating such that one DL period is followed by one UL period, or vice versa, or different numbers or durations, e.g. (roughly) 3:1 (e.g., 3 DL periods followed by a TDD guard period and 1 UL period), or (roughly) 2:1, or even (roughly) 1:2 or 1:NU with NU 3 or larger, for UL heavy scenarios. UL period durations may be the same as DL period durations, or different. The distribution and/or duration of DL and UL periods may be referred to as TDD pattern; the TDD pattern may be dynamically controllable (e.g., with DCI signalling), and/or configured or configurable, e.g. with higher layer signalling like RRC signalling or RLC signalling, and/or may be semi-statically configurable or configured. The TDD pattern may describe the smallest time domain distribution of DL period/s and/or UL period/s and/or TDD guard period/s repeated over time, e.g. in one or more frames and/or subframes and/or slots and/or a time duration covering multiple repetitions of the TDD pattern.

It may be considered that the radio node is adapted for utilising a number NP of antenna sub-arrays and/or panels, wherein NP may be an integer number of 4 or larger. An antenna sub-array may comprise a plurality of antenna elements, e.g. 4 or more, or 10 or more, or 50 or more, or 100 or more. An antenna sub-array, and/or the antenna elements associated thereto and/or comprised therein, may be associated and/or connected or connectable to one and/or the same antenna circuitry, and/or be jointly controllable for analog and/or digital beam-forming, and/or be operable for joint transmission or reception. A panel may comprise a support structure, e.g. plastics and/or metallic material and/or wood, supporting one or more antenna sub-arrays, which additionally may support additional circuitry like antenna circuitry and/or interface circuitry. Each antenna sub-array may be associated for one communication direction (e.g., reception or transmission) and/or one functionality, e.g. communication. It may be considered that antenna elements of an antenna sub-array share the same polarisation, e.g. horizontal or vertical. In some cases, NP may be an even number, wherein it may be considered that NP/2 antenna sub-arrays (and/or their antenna elements) may be associated to a first polarisation (e.g., horizontal or vertical or left-circular or right-circular, or any other suitable polarisation) and the other NP/2 antenna sub-arrays are associated to a second polarisation, which may be orthogonal to the first polarisation. For example, the first polarisation may be horizontal with the second polarisation being vertical, or the first polarisation may be left-circular and the second polarisation may be right-circular. This allows multiple beams to be operated, with good flexibility and/or large signalling capacity. In general, an antenna arrangement associated to a radio node may comprise one or more antenna sub-arrays, in particular an even number of antenna sub-arrays. In general, at different times, different antenna sub-arrays and/or panels may be used for different functions, e.g. transmission or reception, and/or communication. The polarisation of an antenna element may be associated to a specific operation direction, e.g. for transmission or reception. Depending on signalling direction (transmission or reception), polarisation may be different. For example, an antenna sub-array may be associated to a first polarisation for transmission, and a second polarisation for reception, or vice versa. This may be achieved, for example, by providing crossed linear antenna elements for the sub-arrays, with associated connections/circuitry according to polarisation.

A transmitter may generally represent a device adapted for transmission, but it also may be adapted for reception, and/or represent a TRP or radio node or antenna arrangement. In some cases, a transmitter or TRP may be controlled by a radio node, e.g. a network node or transmitting radio node; such a node may control one or more transmitters, e.g. a first transmitter and second transmitter.

It may be considered that operating utilising signalling like communication signalling, and/or communicating utilising signalling like communication signalling, may comprise transmitting the signalling, e.g. communication signalling, and/or receiving the signalling, e.g. communication signalling. It may be considered that signalling like communication signalling is based on an OFDM wave-form, e.g. OFDM, or DFT-s-OFDM, or pulse-shaped DFT-s-OFDM. Such a wave-form is particularly suitable for wireless communication at high frequencies and/or with high communication loads. A cyclic appendix may generally be a cyclic prefix, or a cyclic suffix. The appendix may represent a repetition of a part of signalling carried by a symbol at its start (suffix) or end (prefix), which may be appended at the opposite of the symbol (end or start); e.g. a cyclic prefix may be considered a repetition of the signalling at the end of the symbol it pertains to. The communication signalling may be based on a waveform with cyclic appendix. A cyclic appendix may be associated to a specific symbol, it may have a duration shorter than the symbol duration, e.g. ¼ or less than ¼ of the symbol duration, or ⅙ or less than ⅙.

A radio node, like a transmitting radio node or receiving radio node, may be a wireless device or user equipment or terminal. Alternatively, it may be a network node or signalling radio node. A radio node adapted for wireless communication may be a radio node adapted for transmitting and/or receiving communication signalling. Communication signalling may be. and/or comprise, data signalling and/or control signalling and/or reference signalling, e.g. according to a wireless communication standard like a 3GPP standard or IEEE standard. Operating utilising communication signalling may comprise transmitting and/or receiving communication signalling. The radio circuitry and/or processing circuitry and/or antenna circuitry of a radio node may be adapted for handling communication signalling The radio node may be adapted for full-duplex operation, and/or half-duplex operation. Full duplex may refer to transmitting and receiving at the same time, e.g. using the same or different circuitries, and/or using different antenna sub-arrays or separately operable antenna sub-arrays or antenna elements. The communication signalling may be beam-formed.

A DFT-s-OFDM based wave-form may be a wave-form constructed by performing a DFT-spreading operation on modulation symbols mapped to a frequency interval (e.g., subcarriers), e.g. to provide a time-variable signal. A DFT-s-OFDM based wave-form may also be referred to a SC-FDM wave-form. It may be considered to provide good PAPR characteristics, allowing optimised operation of power amplifiers, in particular for high frequencies. In general, the approaches described herein may also be applicable to Single-Carrier based wave-forms, e.g. FDE-based wave-forms. Communication, e.g. on data channel/s and/or control channel/s, may be based on, and/o utilise, a DFT-s-OFDM based wave-form, or a Single-Carrier based wave-form.

Communication may in particular on multiple communication links and/or beams and/or with multiple targets (e.g., TRPs or other forms of transmission sources also receiving) and/or multiple layers at the same time; different reference signallings for multiple transmission or reception may be based on different sequence roots and/or combs and/or cyclic shifts. Thus, high throughput may be achieved, with low interference. In general, different reference signallings (e.g., of the same type) may be associated to different transmission sources and/or beams and/or layers, in particular if transmitted simultaneously and/or overlapping in time (e.g., considering different timing advance values if transmitted in uplink). For example, there may be first reference signalling transmitted using a first transmission source and/or first beam and/or first layer, and second reference signalling transmitted using a first transmission source and/or first beam and/or first layer.

There is also described a program product comprising instructions causing processing circuitry to control and/or perform a method as described herein. Moreover, a carrier medium arrangement carrying and/or storing a program product as described herein is considered. An information system comprising, and/or connected or connectable, to a radio node is also disclosed.

### BRIEF DESCRIPTION OF THE DRAWINGS

The drawings are provided to illustrate concepts and approaches described herein, and are not intended to limit their scope. The drawings comprise:

FIG. 1, showing an exemplary signalling scenario;

FIG. 2, showing another exemplary signalling scenario;

FIG. 3, showing another exemplary signalling scenario;

FIG. 4, showing another exemplary signalling scenario;

FIG. 5, showing another exemplary signalling scenario;

FIG. 6, showing an exemplary receiving radio node or wireless device; and

FIG. 7, showing an exemplary transmitting radio node or network node.

### DETAILED DESCRIPTION

In the following, reference is being made to a random access procedure, and/or associated messages. However, the approaches described may be applicable in other contexts, e.g. exchange of messages in high-speed scenarios (e.g., with drones and/or trains and/or vehicles) and/or IoT (Internet-of-Things) scenarios and/or for transmission on different carriers and/or different beams, and may for example be applicable for control signalling and/or data signalling also outside of a random access procedure. A UE may be seen as an exemplary receiving radio node or wireless device.

Random access (RA) may be performed by a wireless device to access a cell and/or to start communication and/or to synchronise to a network, in particular for uplink synchronisation, and/or for handover or other purposes. A receiving radio node like a wireless device or UE may be considered to be adapted to perform random access, e.g. to perform one or more actions like transmissions and/or reception associated to a random access procedure on the device side; a transmitting radio node like a network node may be considered to be adapted to perform random access, e.g. to perform one or more actions like transmissions and/or reception associated to a random access procedure on the network side. A UE or wireless device may be considered an example of a receiving radio node, and the terms may be interchanged. A network node or gNodeB may be considered an example of a transmitting radio node and the terms may be interchanged.

In general, a wireless device may receive synchronisation signalling transmitted from the network (e.g., a signalling radio node), e.g. a transmitted SS/PBCH beam SSB0, SSB1, . . . . Reception of the SS/PBCH beam SSB0, . . . may be with a reception beam, which may for example be associated to a random access transmission beam PRACH beam 0, 1, . . . for the wireless device, and/or to the SS/PBCH transmission beam (associated in this context may indicate the inverse/reverse beam, and/or a beam in a specific reception direction). A reception beam may be associated to a SS/PBCH transmission beam, or to a group of such, e.g. comprising two or more SS/PBCH transmission beams, e.g. corresponding to a reception beam like a PRACH Rx beam having twice the width of a SSB beam. The wireless device may determine the best received SS/PBCH transmission, e.g. based on reception within a FFT window to sample the signalling, and transmit a random access preamble in response to indicate it wants to perform random access. A random access preamble may also be referred to as message 1 or Msg1; it may be represented by a sequence of symbols to be transmitted, e.g. selected from a set (or two sets or more sets) of preambles available (e.g., according to configuration and/or indicated by the SS/PBCH received); the selection may be randomised, or in some cases, indicated by the network node, for example configuring a specific set and/or preamble to the wireless device. The Msg1 or preamble may be transmitted in a random access resource (also referred to as random access occasion), which may be indicated by and/or dependent on the SS/PBCH received, and/or be associated to the specific set of preambles the preamble is selected from. It may be considered that the RA preamble is transmitted using a subcarrier spacing or numerology different from the one used for communication; the SCS for RA may be for example be 960 kHz, wherein the communication SCS may be 1920 kHz. The transmission of the RA preamble may comprise a number of repetitions of the preamble and/or a cyclic prefix. When a preamble sequence arrives at the network node, may depend on the distance between the wireless device and the receiving network node. The RA preamble transmission may be received with SSB reception beams, to e.g. determine the best reception. The received SSB may in general be used for cell identification and synchronisation by the wireless device. However, for transmissions to the network node (UL), timing might be off due to signalling traveling time; the wireless device may generally acquire a timing advance (TA) value for UL transmissions, which may be provided by the network node. The maximum delay of RA preamble reception may be indicative of a cell size or communication radius, which may be related to a maximum allowed TA. After receiving the preamble, a network node may transmit a random access response (RAR) or message 2 (Msg2), which may provide a timing advance value (TA1) and schedule resources for uplink transmission, e.g. on a PUSCH, using a message 3 (Msg3). The Msg3 may be transmitted using the provided timing advance value (TA1) and/or according to the communication SCS, which may in general shift the transmission to an earlier point in time in relation to the downlink timing to accommodate the signal traveling time for UL transmission (e.g., so that the network may receive synchronised signalling). Msg3 may be a contention resolution request, e.g. containing details of the identity of the wireless device to enable to network to unambiguously identify wireless devices to finish random access. A Msg4 transmitted by the network node may resolve the contention and/or provide setup for communication, e.g. to perform an RRC setup procedure. In general, multiple wireless device may try to access the network at the same time, e.g. using the same preamble or same set of preambles and/or the same random access resources. The contention resolution may facilitate resolving issues arising with multiple random access attempts. If a wireless device does not receive a RAR, it may retransmit the RA preamble with increased power, e.g. using power ramping, until it receives a response and/or a maximum transmission power has been reached. In general, random access messages transmitted by a network node or signalling radio node (e.g., Msg2, Msg4) may be transmitted on a data channel, e.g. PDSCH or PSSCH; such transmission may be scheduled with a control channel message and/or on a PDCCH or PSCCH, e.g. a DCI format message or SCI format message. The control channel message may be associated to a search space or CORESET, which may be configured or configurable with higher layer signalling, e.g. with PBCH signalling and/or RRC layer signalling, e.g. in a SS/PBCH transmission and/or a data channel transmission, e.g. on PDSCH (e.g., for specific configuration or as System Information multicast or broadcast, e.g. associated to PBCH signalling). In an alternative approach, instead of Msg1 and 3, a single message may be transmitted, e.g. a message A or MsgA. MsgA may comprise a preamble part and/or a part with coded data, similar to a PUSCH transmission. In response to a MsgA, there may be transmitted a MsgB, e.g. instead of a Msg2 and Msg4. MsgB may be similar to a PDSCH transmission. This may be part of a 2-step RA procedure. For some uses cases, e.g. synchronisation, it may be sufficient to exchange Msg1 and Msg2 in a shortened 4-step procedure. A MsgB, and/or Msg2 or Msg4 may comprise one or more message parts, e.g. a scheduling assignment (e.g., DCI and/or PDCCH) and/or a scheduled data channel transmission. A MsgB or Msg2 may in general schedule a transmission by the receiving radio node or UE.

In some cases, the synchronisation signalling (SS/PBCH or SSB) may be transmitted from a different TRP or node than a later MsgB. If MsgB is transmitted from another node/TRP than the SSB, the UE RX timing (obtained from SSB reception) may not be valid anymore, e.g. due to potentially different path delays from different network nodes/TRPs to the UE. Similar effects could appear if the UE moves quickly enough that the path delay significantly changes between reception events; this may be due to a different part-beam (e.g., different reflection of the original beam) becoming dominant. Moreover, similar effects could appear regarding the received power. In general, scenarios with relatively large jumps in path delay or received power may be considered.

It may be considered pre-fixing the MsgB with a timing-error-robust preamble. The UE may receive the MsgB preamble with SSB timing, and may adjust its receive timing based on preamble reception, to use the new timing for subsequent reception. A UE may adjust autonomously its transmit timing based on new reception timing. If the UE is not fast enough (e.g., due to processing capability, e.g. in an IoT scenario) to determine a new reception timing, the preamble can be sent with a gap between preamble and MsgB in time domain, e.g. to allow processing. A preamble may be seen as sync reference signal, e.g. sync-CSI-RS. In general, a preamble may represent a preamble part, or be comprised therein.

A (sync) preamble may be based on double-symbol structure, which may for example be used for MsgA and/or MsgB. It may be generated together with other signals at base station or transmitting radio node (e.g., by shifting the signalling on one symbol relative to the signalling on another neighbouring symbol of the preamble, e.g. by applying a phase ramp to subcarriers of first preamble symbol: this cyclic shifts the preamble but not signals mapped to other subcarriers). As long as propagation time difference (path delays) between SSB and MsgB is less than an OFDM symbol, UE can use FFT timing based on SSB reception and determine new FFT timing from observed cyclic shift within FFT1 window. It may generally be considered that a receiving radio node or UE may be adapted to able to buffer, and/or to buffer, MsgB samples (which may include a preamble part and/or message part or message), based on which it may adjust FFT timing, and perform FFT2 based on new timing. For example it may be considered to adjust FFT1 timing (e.g., based on using FFT1 on the preamble or preamble part) to FFT2 timing, using FFT2 to process message or message part, or using FFT1 on the message/message part to adjust timing to FFT2, and use FFT2 to process message or message part. Alternatively, or additionally, there may be a gap between preamble and message or message part, e.g. a PDCCH of the message. The gap may cover and/or have a duration of one or more symbols, and/or may be adapted to accommodate processing, and/or may be based and/or reflect processing capacity of one or more receiving radio nodes or capability classes (indicating capability or processing capacity of a class of UEs or receiving radio nodes). The preamble could be seen as sync-CSI-RS, in particular if there is a time domain gap. In general, the preamble or preamble part may precede in time domain the message or message part. If MsgB also contains a PDSCH, this can be scheduled with or without (time domain) gap using scheduling via PDCCH (PDSCH and PDCCH may be considered to have same timing).

It may be generally considered that a MsbB configuration and/or preamble configuration, or more generally, a signalling configuration is broadcast and/or provided with system information signalling, e.g. transmitted with a first transmitter and/or with synchronisation signalling, and/or indicated thereby (e.g., with scheduling or indicating broadcast or system information signalling providing configuration information. The signalling configuration and/or configuration information may indicate the format of first signalling, e.g. the presence or absence, and/or format or time domain structure and/or (transmission) power level and/or sequence and/or sequence root, and/or shift), of pilot signalling and/or preamble part and/or message part/s.

Presence of preamble or preamble part may be based on SSB and MsgB being transmitted from different nodes or TRP, which may be a network design choice and/or indicated with broadcast or system information signalling. It may be considered that a signalling configuration, e.g. a MsgB preamble configuration (indicating, for example, if present, and/or detailed preamble configuration) broadcast in SI. A MsgB preamble configuration may be SSB specific, or cell-specific (or specific to all SSBs controlled by the same node and/or transmitted by the same TRP).

In the Figures, symbol content (proper symbol) is indicated with white background; prefixes are shown striped. The duration of symbol time intervals and/or transmission timing structures and/or numerology between different signallings may be the same or different; for example, synchronisation signalling may have a different numerology than a first signalling. PDCCHn and/or PDSCHn may be considered to indicate different symbols associated to the same PDCCH or PDSCH, respectively (the PDSCH may represent a data channel transmission, and/or a MsgB transmission covering more than one symbol time interval). For different n, the symbol content may be different, e.g. in terms of carrying data and/or reference signalling like DM-RS, and/or encoded bits.

MsgB may be considered an example of first signalling and/or may be replaced by any message, e.g. sent from a node or with a beamforming unknown to the receiving radio node or UE from a transmitter. Examples would be a response sent to a random access message sent from a different node. Where the node could be in a different location, or using a different antenna or antenna arrangement, or antenna weights or using a different frequency. MsgB could also be an example for a reference signal received with an unknown power.

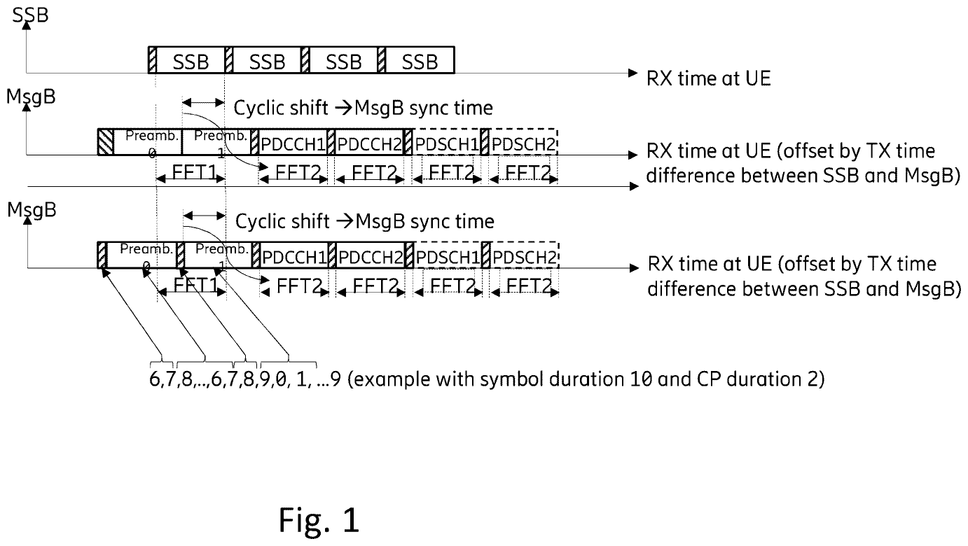

FIG. 1 shows an exemplary signalling scenario. A receiving radio node like a UE may receive an SSB (shown here in the uppermost line, covering and/or being carried on 4 consecutive symbol time intervals), which may be transmitted by a first transmitter, e.g. a first TRP1. The SSB, or more general, system information signalling and/or synchronisation signalling, may be received at a reception timing RX at a UE; based on the received SSB, the UE may transmit a MsgA, in response to which the network may transmit a MsgB, e.g. using a different TRP, or on different carrier. The middle line and lower line show different variants of transmitting a MsgB (message part) with a preamble (preamble part). In the middle line, the preamble part comprises a preamble covering two (or more) symbol time intervals. A cyclic prefix is provided with extended duration at the first symbol time interval only; it may be considered that the preamble part covers only one symbol time interval that has double the symbol time interval duration than the message part. In the lower line, there is shown a variant in which the preamble symbols each carry a prefix. It may be considered that the contents of the symbols of the preamble are (e.g. cyclically) shifted to each other, which makes determining a timing (e.g., using a first FFT window and timing FFT1) easier. In the example, there may be symbol content covering samples or modulation symbol content 0 to 9; the prefix of Preamble1 may comprise or consist of 8.9 (with prefix size 2), the prefix of Preamble0 may comprise or consist of 6.7. Preamble0 may generally be cyclically extend by the prefix of Preamble1, and/or the Preamble symbols or parts and/or prefixes may be adapted to be shifted, in particularly cyclically shifted and/or to present a cyclic extension of each other. It may be considered that different symbols or the preamble or preamble part are associated to each other, e.g. cyclically shifted and/or extended.

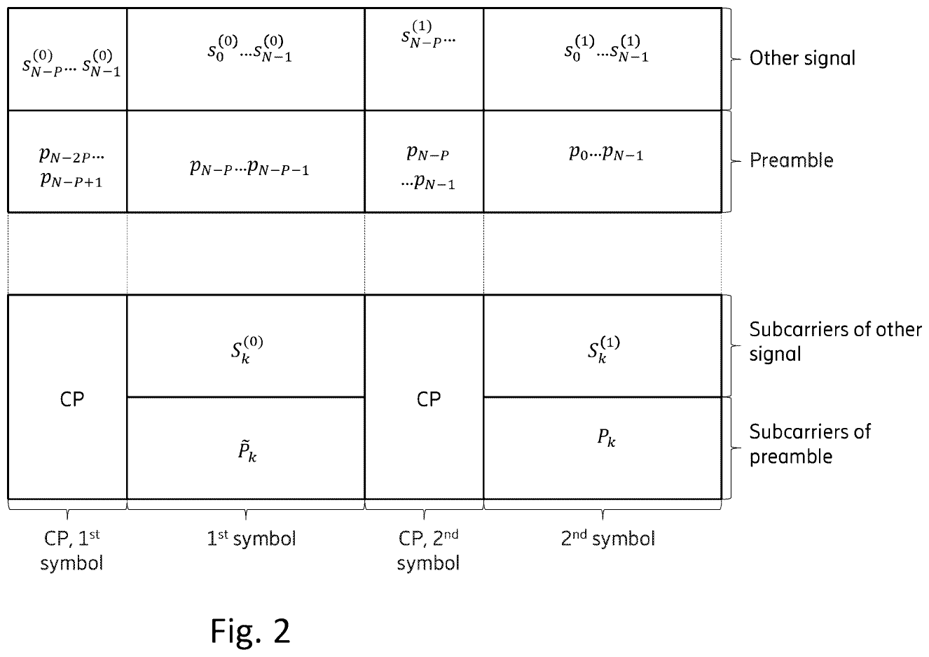

FIG. 2 shows variants regarding preamble parts. The upper line corresponds to the variant with one extended prefix CP for two (or more) symbol time intervals or preamble symbols. A second signalling structure, which may e.g. be used in a different part of the frequency spectrum and/or a different carrier, and/or at a different time, is shown as other signal for comparison. The preamble may be based on, and/or represent, a sequence of N elements (e.g., bits and/or samples and/or modulation symbols), p₀ to p₍N−1). The last (second) preamble symbol time interval or symbol content may represent the sequence, with a CP of size (N−P−1) providing a cyclic extension. The prefix is cyclically extended (pre-pended) by the leading preamble symbol, with its own cyclic prefix. Thus, the contents of the symbols of the preamble are shifted relative to each other. The lower line of FIG. 2 shows a few regarding the subcarriers for the preamble variant. In the first symbol, the subcarriers of the preamble are modulated with the preamble sequence after applying a linear phase shift (to cyclic shift the preamble): \tilde{P}ₖ=Pₖ×e^{(-2π/NkP)}. This corresponds to the sequence-based perspective of the upper line.

When MsgB is transmitted from another node than SSB node, received power at UE might be very different from received SSB power (likely lower TX power and/or BF, but closer distance; other cases may be conceived of). MsgB could be sent with a lower power, based on received PRACH power (e.g., of a MsgA). The reception may in general be based on tuning and training reception circuitry, e.g. for AGC (Automatic Gain Control). A double duration CP (e.g., 2.3 μs with 60 kHz) in front of a preamble may be used to train AGC, if this is sufficiently long. This may be extended by delaying MsgB FFT timing by a few μs (which may eat up allowed delay difference. In this case, a preamble part may be considered to represent and/or comprise pilot signalling, wherein the preamble, and/or the cyclic prefix of a first preamble symbol, may represent the pilot signalling. If UE AGC (Automatic Gain Control) is not fast enough, MsgB may be prefixed with an AGC-preamble that enables AGC training; thus, additional pilot signalling may be provided. This may also be used in cases without preamble. Alternatively, or additionally, the preamble may be extended, (e.g. using same sequence as preamble), for example preceded by triple-CP (with three preamble symbols, or NPA-duration prefix for NPA preamble symbols). The extended prefix may be extended in comparison to a regular prefix, e.g. for a given numerology and/or a symbol carrying data signalling and/or control signalling.

It may be considered prepending, to a MsgB transmission, an additional reference signal (pilot signalling) for the UE to train on. If the MsgB is preceded with a preamble for synchronization, the AGC pilot may be placed before this in time domain. The pilot signalling may be placed directly in front of the MsgB and/or preamble, e.g. bordering in time domain a symbol carrying preamble and/or MsgB, or with a time-gap. A time gap would allow more time for the receiver to reset or tune AGC levels.

The frequency allocation may be the same as the MsgB, or different; the expected received power may be similar, and/or the (expected) received power and/or signal strength of the pilot signalling may be indicative of, and/or similar, or equal, to the (expected) received power and/or signal strength of the MsgB or first signalling and/or preamble or preamble part and/or message or message part, e.g. per time interval, e.g. per transmission timing structure and/or symbol time interval, or slot, or subslot, or subframe.

The pilot signalling (AGC pilot) may carry and/or represent information, e.g. a transmission power level. The information carried by the AGC pilot may be only encoded in the power level. The UE could in some variants assume that MsgB would be received with the same power level as the pilot. In other variants, the UE may assume a preconfigured offset in the power of the AGC pilot and the MsgB. This would allow sending the AGC pilot over a smaller resource and with less power. In other variants, the power level and/or offset could be encoded within the AGC pilot.

In some variants, the AGC pilot may be defined as a specified sequence, while in other variants, the UE may be instructed to monitor the power in a predefined time/frequency resource.

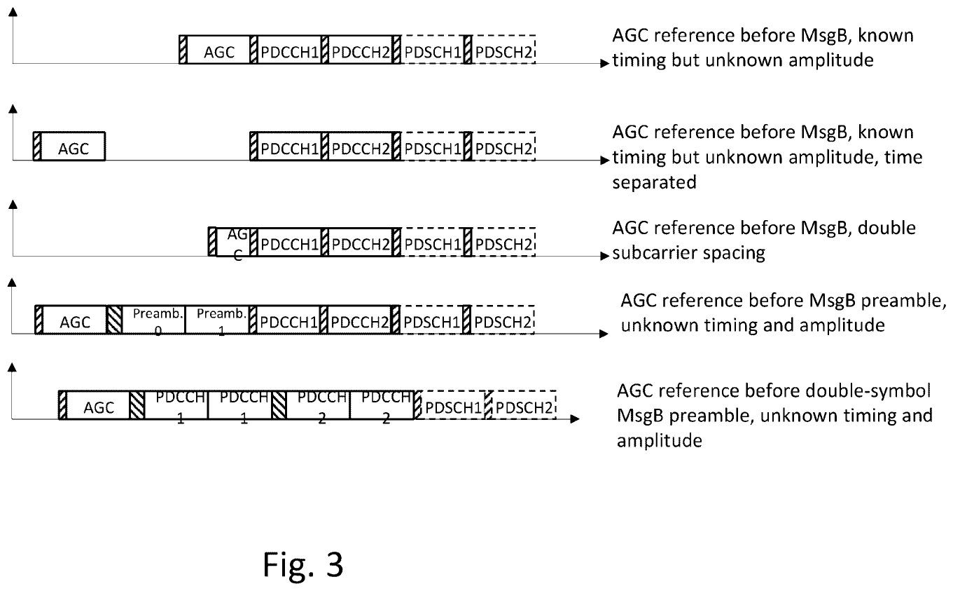

The time domain resource for a AGC pilot may be defined as a OFDM symbol in an OFDM system (or similarly, SC-FDM symbol in a SC-FDM system). The symbol may in general follow the MsgB subcarrier spacing, or a different subcarrier spacing, if e.g. a shorter signal is sufficient. In some variants, it could be defined as a time domain signal stretching a number of samples in a symbol, or over more than one symbol. A AGC pilot may be defined to have a rather flat amplitude response in frequency and over the time the signal is monitored, be it a full symbol or a fraction of a symbol. To reduce interference, and totally transmitted power, a sequence may be selected with a lower amplitude in the first part of symbol, in time-domain, if not the full symbol is used for AGC training in the UE. FIG. 3 shows different examples of using pilot signalling and/or AGC pilot, with different message structures and/or first signalling to which the AGC pilot is associated and/or pertains to.

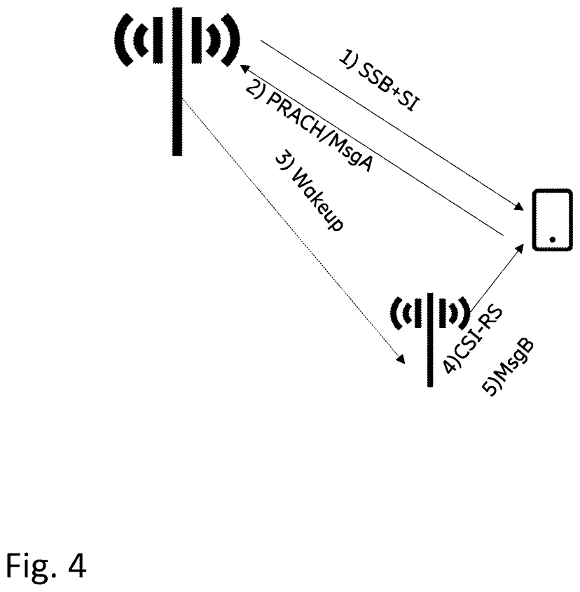

FIG. 4 shows an exemplary signalling scenario, in which a first transmitter like a SSB node sends SSB and SI, potentially including sync-CSI-RS configuration, and/or MsgB configuration, e.g. in action 1. The configuration may include and/or indicate at least one of time window, frequency (e.g., incl. carrier), sequence, scrambling of sync-CSI-RS and MsgB, etc (any information enabling reception of MsgB, and/or synchronisation to MsgB). The SSB node may receive PRACH/MsgA in action 2. The receiving radio node (UE) may transmit the MsgA or PRACH, e.g. in response to receiving SSB and/or SI and/or system information signalling. The first transmitter, or a node controlling it, e.g. a SSB node, may in an action 3 wake up, and/or inform, a second transmitter, e.g. another node or TRP, to transmit MsgB; this may include providing information regarding the target like the UE or receiving radio node, and/or beam forming information and/or location and/or content of the MsgB, and/or the MsgB (e.g. before encoding, or encoded, or modulated).

The MsgB-transmitting node may send MsgB or first signalling, e.g. with sync-CSI-RS, e.g a preamble, or a multi-symbol repetition PDCCH or PDSCH or message or message part, e.g with or without AGC pilot in an action 4. Information in action 3 may indicate beam direction and/or beam size for transmission of MsgB. The first signalling or MsgB may be received at UE within time-window relative to MsgA transmission, e.g. as indicate by system information signalling and/or in a ion 1. The receiving node and/or UE may adjust its timing based on the first signalling. MsgB may be transmitted in a defined time window. UE uses the timing obtained from sync-CSI-RS for reception (e.g., decoding and/or demodulation) of the message content of the first signalling, and/or to update its transmission timing, e.g. for a following transmission of a message indicating reception of the MsgB or first signalling, e.g. a HARQ response and/or a message indicating establishment of RRC connection and/or successful random access (from the UE side).

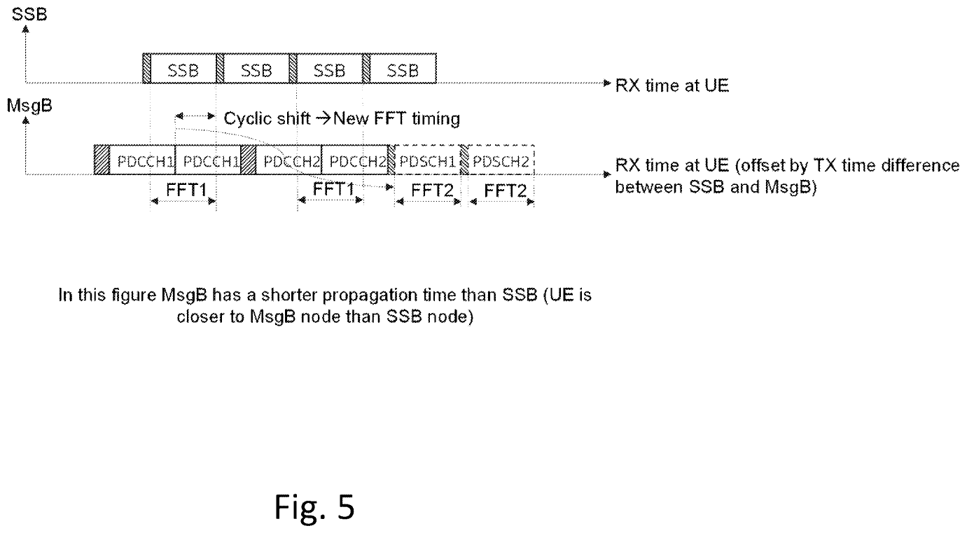

An alternative to using a preamble is discussed in context of FIG. 5.

When first signalling like a MsgB is transmitted from another node or carrier than SSB, or after a long delay, the UE RX timing (e.g., obtained from SSB reception, or during other communication) may not be valid anymore. It is proposed to transmit the first signalling, e.g. a message like MsgB (or the PDCCH message scheduling a data reception) with a double-symbol (or multiple) repetitive structure, which may be robust towards timing error. The receiving radio node or UE may receive MsgB (PDCCH) with SSB timing; it may receive its timing based on MsgB (PDCCH) reception and use new timing for subsequent reception, e.g. of a message on a data channel scheduled by the MsgB (PDCCH). MsgB PDSCH (if present) may be sent with normal symbol structure and received with new timing, or may be sent with a multi-symbol repetitive structure as well, e.g. if there is no or a small time gap between the scheduling assignment (PDCCH) and the PDSCH. UE may adjust autonomously its transmit timing based on new reception timing.

The repetitive time domain structure (double-symbol or multi-symbol structure) may be generated together with other signals at base station. The UE may receive MsgB PDCCH with SSB timing (for example, assuming propagation time difference between SSB and MsgB is less than an OFDM or SC-FDM symbol duration), and may determine new FFT timing, e.g. from observed cyclic shift within FFT1 window. MsgB PDSCH (if any) could be scheduled with short gap (if needed) and normal symbol structure. Pilot signalling (e.g., AGC pilot) may be present as described herein. Using this structure may lower processing demands, and/or may optimise signalling overhead.

Cyclic shift may be estimated based on DM-RS of PDCCH1 and/or PDCCH2. DM-RS may be on a comb; the signal may repeat itself within the symbol time interval it is mapped to, which may reduce max allowed time difference between SSB and MsgB node. DM-RS may be on a comb-4: Max allowed time difference is quarter of a symbol (60 kHz: 1.25 km), or on a comb-2. Each PDCCH symbol may contain DM-RS, or only one or some of all PDCCH symbols may contain DM-RS (it may be considered that symbols containing DM-RS may also contain modulation symbols and/or bits of the PDCCH, e.g. interspersed between subcarriers of a comb crying DM-RS. In some varaints, only one, e.g., a first in time domain, PDCCH1 symbol may contain DM-RS (e.g., on a comb-2); max allowed time difference may be half of a symbol (60 kHz: 2.5 km); in some cases, no DM-RS may be in PDCCH2 or further symbols of the PDCCH.

FIG. 5 shows an example scenario with double-symbol repetitive PDCCH; in the alternative, or additionally, double- or multi-symbol PDSCH may be considered, e.g. for a very short (one or two symbol) PDCCH. As shown in FIG. 5, a PDCCH having multiple (in this case, 2) symbol contents PDCCH1, PDCCH2, may be transmitted in a double-symbol repetition structure, wherein the symbol content PDCCH1 is transmitted twice in bordering symbols, and symbol content PDCCH2 is transmitted twice in bordering symbols as well. The symbol content of PDCCH1 and/or PDCCH2 may comprise control information, e.g. DCI, and/or DM-RS. Symbol content (e.g., DM-RS and/or control information) of each symbol associated to one symbol content may be shifted relative to each other, e.g. based on cyclic shift and/or linear phase ramping. For example, PDCCH1 in the leading symbol may be shifted relative to PDCCH1 in the second symbol, and/or analoguous for PDCCH2. The control information may be encoded control information, and/or may schedule a data transmission to be received by the receiving node (e.g., PDSCH, for example of a MsgB), or schedule a transmission by the receiving radio node, and/or may include information of a MsgB. A cyclic prefix of extended duration may be prefixed to the first symbol of each double- or multi-symbol, e.g. as described in the context of the preamble.

In some cases, a MsgB may include an indication of timing advance, which may be obsolete, as it may be determined based on receiving a MsgA or other signalling using the first transmitter/TRP or radio node. In this case, it may be considered that the receiving radio node omits and/or ignores the timing advance, and/or determines a new timing advance, e.g. based on the indicated timing advance and/or a timing difference between the timing to the first transmitter and the adjusted timing determined for the first signalling. This may be indicated in broadcast signalling and/or system information signalling. Alternatively, a MsgB may be transmitted without a timing advance indication, lowering signalling overhead. The format and/or content of the MsgB may be indicated or configured in broadcast signalling and/or system information signalling, e.g. SSB or PBCH or PDSCH signalling.

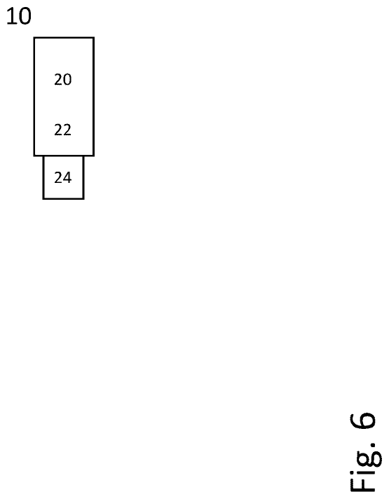

FIG. 6 schematically shows a radio node, in particular a wireless device or terminal 10 or a UE (User Equipment). Radio node 10 comprises processing circuitry (which may also be referred to as control circuitry) 20, which may comprise a controller connected to a memory. Any module of the radio node 10, e.g. a communicating module or determining module, may be implemented in and/or executable by, the processing circuitry 20, in particular as module in the controller. Radio node 10 also comprises radio circuitry 22 providing receiving and transmitting or transceiving functionality (e.g., one or more transmitters and/or receivers and/or transceivers), the radio circuitry 22 being connected or connectable to the processing circuitry. An antenna circuitry 24 of the radio node 10 is connected or connectable to the radio circuitry 22 to collect or send and/or amplify signals. Radio circuitry 22 and the processing circuitry 20 controlling it are configured for cellular communication with a network, e.g. a RAN as described herein, and/or for sidelink communication (which may be within coverage of the cellular network, or out of coverage; and/or may be considered non-cellular communication and/or be associated to a non-cellular wireless communication network). Radio node 10 may generally be adapted to carry out any of the methods of operating a radio node like terminal or UE disclosed herein; in particular, it may comprise corresponding circuitry, e.g. processing circuitry, and/or modules, e.g. software modules. It may be considered that the radio node 10 comprises, and/or is connected or connectable, to a power supply. A DFE may be considered part of radio circuitry; an analog frontend may be associated to radio circuitry and/or antenna circuitry.

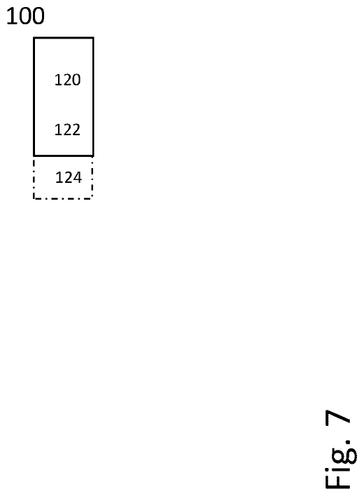

FIG. 7 schematically shows a radio node 100, which may in particular be implemented as a network node 100, for example an eNB or gNB or similar for NR. Radio node 100 comprises processing circuitry (which may also be referred to as control circuitry) 120, which may comprise a controller connected to a memory. Any module, e.g. transmitting module and/or receiving module and/or configuring module of the node 100 may be implemented in and/or executable by the processing circuitry 120. The processing circuitry 120 is connected to control radio circuitry 122 of the node 100, which provides receiver and transmitter and/or transceiver functionality (e.g., comprising one or more transmitters and/or receivers and/or transceivers). An antenna circuitry 124 may be connected or connectable to radio circuitry 122 for signal reception or transmittance and/or amplification. Node 100 may be adapted to carry out any of the methods for operating a radio node or network node disclosed herein; in particular, it may comprise corresponding circuitry, e.g. processing circuitry, and/or modules. The antenna circuitry 124 may be connected to and/or comprise an antenna array. The node 100, respectively its circuitry, may be adapted to perform any of the methods of operating a network node or a radio node as described herein; in particular, it may comprise corresponding circuitry, e.g. processing circuitry, and/or modules. The radio node 100 may generally comprise communication circuitry, e.g. for communication with another network node, like a radio node, and/or with a core network and/or an internet or local net, in particular with an information system, which may provide information and/or data to be transmitted to a user equipment. A DFE may be considered part of radio circuitry; an analog frontend may be associated to radio circuitry and/or antenna circuitry.

In general, the wireless device and/or network node may operate in, and/or the communication signalling may be in TDD operation. It should be noted that the transmission of signalling from transmission sources may be synchronised and simultaneous; a shift in time may occur due to different propagation times, e.g. due to different beams and/or source locations.

A data block may refer to a transport block, or a code block or a code block bundle. A code block may comprise and/or represent a number of (information) bits representing information (e.g., data or control information), to which there may be associated, and/or which may further include, bits for error detection coding, e.g. CRC. The bits for error detection coding may be determined based on the (information) bits, and/or may be error detection bits for the (information) bits. A code block bundle may comprise one or more code blocks; wherein each code block may have associated to it, and/or comprise, error correction bits. The error correction bits in a code block bundle may each pertain to an associated code block; error correction bits may be specific to only one code block, e.g. determined based on bits of only one code block. Different bits and/or groups of bits may be associated to different code blocks. Error correction bit/s associated to a code block may be associated to a single code block; this may refer to the error correction bits indicating correctness/incorrectness of the single code block, and/or calculated and/or determined based only on (information) bits of the single code block. Information bits may represent data and/or control information, e.g. associated to a data channel (data information/bits) and/or control channel (control information/bits) code block bundle may be a data block without error correction coding pertaining to more than one code block. A transport block may comprise error detection coding pertaining to a plurality of code blocks, e.g. covering the code blocks it consists of. A transport block may comprise one or more code blocks. It may be considered that a data block may be associated to, and or subject to, and/or correspond to, a, one and/or a single acknowledgement process, e.g. a specific HARQ process, which may correspond to and/or be represented by a HARQ identifier. A code block may correspond to a subpattern of an acknowledgement information bit pattern. In some cases, a data block may correspond and/or pertain and/or be subject to a plurality of acknowledgement processes, e.g. if there is one acknowledgement process per code block of the data block.

A data block may comprise and/or represent information bits, which may be data bits (e.g., user data) and/or control information bits; the information bits may be associated to one or more data or control channels, e.g. transport channels and/or logical channels, and/or may be mapped to a specific and/or single physical channel, in particular a physical data channel, or in some cases, a physical control channel (in which case it may or may not be associated to a higher layer channel like a transport channel or logical channel). A data block may represent bits intended for transmission, e.g. encapsulating one or more higher layer data packets, e.g. one or more MAC layer data packets, e.g. one or more PDUs (Protocol Data Unit) and/or SDUs (Service Data Unit); error correction bits, e.g. CRC; may be added in physical layer processing. It may be considered that bits of a data block are subject to physical layer processing like coding (e.g., forward error coding and/or adding error correction coding) and/or rate matching and/or scrambling, and/or modulation. Modulation may correspond to mapping of bits of the processed data block to modulation symbols, e.g. according to a modulation scheme and/or to a modulation space. The modulation symbols may be represented as a bit sequence until they are subject to analog conversion (or vice versa for reception).

A wireless device may in general comprise processing circuitry and/or radio circuitry, in particular a receiver and/or transceiver and/or transmitter, for performing measurement and/or to control beam switch and/or control beam-forming and/or receive and/or transmit signalling like communication signalling. The wireless device may in particular be implemented as terminal or a user equipment. However, in some cases, e.g. relay and/or back-link and/or IAB scenarios, it may be implemented as network node or network radio node. A network node may in general comprise processing circuitry and/or radio circuitry, in particular a receiver and/or transceiver and/or transmitter, for transmitting reference signalling and/or a beam switch indication and/or for beam switching and/or to control beam switch and/or control beam-forming and/or receive and/or transmit signalling like communication signalling. The radio node may in particular be implemented as a network node, e.g. a network radio node and/or base station or a relay node or IAB node. How-ever, in some cases, e.g. sidelink scenarios, the second radio node may be implemented as a wireless device or terminal, e.g. a user equipment.

In general, an allocation unit or block symbol may represent and/or correspond to an ex-tension in time domain, e.g. a time interval. An allocation unit or block symbol duration (the length of the time interval) may correspond to the duration of an OFDM symbol or a corresponding duration, and/or may be based and/or defined by a subcarrier spacing used (e.g., based on the numerology) or equivalent, and/or may correspond to the dura-tion of a modulation symbol (e.g., for OFDM or similar frequency domain multiplexed types of signalling). It may be considered that a block symbol comprises a plurality of modulation symbols, e.g. based on a subcarrier spacing and/or numerology or equivalent, in particular for time domain multiplexed types (on the symbol level for a single transmitter) of signalling like single-carrier based signalling, e.g. SC-FDE or SC-FDMA (in particular, FDF-SC-FDMA or pulse-shaped SC-FDMA). The number of symbols may be based on and/or defined by the number of subcarrier to be DFTS-spread (for SC-FDMA) and/or be based on a number of FFT samples, e.g. for spreading and/or mapping, and/or equivalent, and/or may be predefined and/or configured or configurable. A block symbol in this context may comprise and/or contain a plurality of individual modulation symbols, which may be for example 1000 or more, or 3000 or more, or 3300 or more. The number of modulation symbols in a block symbol may be based and/or be dependent on a bandwidth scheduled for transmission of signalling in the block symbol. A block symbol and/or a number of block symbols (an integer smaller than 20, e.g. equal to or smaller than 14 or 7 or 4 or 2 or a flexible number) may be a unit (e.g., allocation unit) used for scheduling and/or allocation of resources, in particular in time domain. To a block symbol (e.g., scheduled or allocated) and/or block symbol group and/or allocation unit, there may be associated a frequency range and/or frequency domain allocation and/or bandwidth allocated for transmission.

An allocation unit, and/or a block symbol, may be associated to a specific (e.g., physical) channel and/or specific type of signalling, for example reference signalling. In some cases, there may be a block symbol associated to a channel that also is associated to a form of reference signalling and/or pilot signalling and/or tracking signalling associated to the channel, for example for timing purposes and/or decoding purposes (such signalling may comprise a low number of modulation symbols and/or resource elements of a block symbol, e.g. less than 10% or less than 5% or less than 1% of the modulation symbols and/or resource elements in a block symbol). To a block symbol, there may be associated resource elements; a resource element may be represented in time/frequency domain, e.g. by the smallest frequency unit carrying or mapped to (e.g., a subcarrier) in frequency domain and the duration of a modulation symbol in time domain. A block symbol may comprise, and/or to a block symbol may be associated, a structure allowing and/or comprising a number of modulation symbols, and/or association to one or more channels (and/or the structure may dependent on the channel the block symbol is associated to and/or is allocated or used for), and/or reference signalling (e.g., as discussed above), and/or one or more guard periods and/or transient periods, and/or one or more affixes (e.g., a prefix and/or suffix and/or one or more infixes (entered inside the block symbol)), in particular a cyclic prefix and/or suffix and/or infix. A cyclic affix may represent a repetition of signalling and/or modulation symbol/s used in the block symbol, with possible slight amendments to the signalling structure of the affix to provide a smooth and/or continuous and/or differentiable connection between affix signalling and signalling of modulation symbols associated to the content of the block symbol (e.g., channel and/or reference signalling structure). In some cases, in particular some OFDM-based wave-forms, an affix may be included into a modulation symbol. In other cases, e.g. some single carrier-based wave-forms, an affix may be represented by a sequence of modulation symbols within the block symbol. It may be considered that in some cases a block symbol is defined and/or used in the context of the associated structure.

Communicating may comprise transmitting or receiving. It may be considered that communicating like transmitting signalling is based on a SC-FDM based wave-form, and/or corresponds to a Frequency Domain Filtered (FDF) DFTS-OFDM wave-form. However, the approaches may be applied to a Single Carrier based wave-form, e.g. a SC-FDM or SC-FDE-wave-form, which may be pulse-shaped/FDF-based. It should be noted that SC-FDM may be considered DFT-spread OFDM, such that SC-FDM and DFTS-OFDM may be used interchangeably. Alternatively, or additionally, the signalling (e.g., first signalling and/or second signalling) and/or beam/s (in particular, the first received beam and/or second received beam) may be based on a wave-form with CP or comparable guard time. The received beam and the transmission beam of the first beam pair may have the same (or similar) or different angular and/or spatial extensions; the received beam and the transmission beam of the second beam pair may have the same (or similar) or different angular and/or spatial extensions. It may be considered that the received beam and/or transmission beam of the first and/or second beam pair have angular extension of 20 degrees or less, or 15 degrees or less, or 10 or 5 degrees or less, at least in one of horizontal or vertical direction, or both; different beams may have different angular extensions. An ex-tended guard interval or switching protection interval may have a duration corresponding to essentially or at least N CP (cyclic prefix) durations or equivalent duration, wherein N may be 2, or 3 or 4. An equivalent to a CP duration may represent the CP duration associated to signalling with CP (e.g., SC-FDM-based or OFDM-based) for a wave-form without CP with the same or similar symbol time duration as the signalling with CP. Pulse-shaping (and/or performing FDF for) a modulation symbol and/or signalling, e.g. associated to a first subcarrier or bandwidth, may comprise mapping the modulation symbol (and/or the sample associated to it after FFT) to an associated second subcarrier or part of the bandwidth, and/or applying a shaping operation regarding the power and/or amplitude and/or phase of the modulation symbol on the first subcarrier and the second subcarrier, wherein the shaping operation may be according to a shaping function. Pulse-shaping signalling may comprise pulse-shaping one or more symbols; pulse-shaped signalling may in general comprise at least one pulse-shaped symbol. Pulse-shaping may be performed based on a Nyquist-filter. It may be considered that pulse-shaping is per-formed based on periodically extending a frequency distribution of modulation symbols (and/or associated samples after FFT) over a first number of subcarrier to a larger, second number of subcarriers, wherein a subset of the first number of subcarriers from one end of the frequency distribution is appended at the other end of the first number of subcarriers.

In some variants, communicating may be based on a numerology (which may, e.g., be represented by and/or correspond to and/or indicate a subcarrier spacing and/or symbol time length) and/or an SC-FDM based wave-form (including a FDF-DFTS-FDM based wave-form) or a single-carrier based wave-form. Whether to use pulse-shaping or FDF on a SC-FDM or SC-based wave-form may depend on the modulation scheme (e.g., MCS) used. Such wave-forms may utilise a cyclic prefix and/or benefit particularly from the described approaches. Communicating may comprise and/or be based on beamforming, e.g. transmission beamforming and/or reception beamforming, respectively. It may be considered that a beam is produced by performing analog beamforming to provide the beam, e.g. a beam corresponding to a reference beam. Thus, signalling may be adapted, e.g. based on movement of the communication partner. A beam may for example be produced by performing analog beamforming to provide a beam corresponding to a reference beam. This allows efficient postprocessing of a digitally formed beam, without requiring changes to a digital beamforming chain and/or without requiring changes to a standard defining beam forming precoders. In general, a beam may be produced by hybrid beam-forming, and/or by digital beamforming, e.g. based on a precoder. This facilitates easy processing of beams, and/or limits the number of power amplifiers/ADC/DCA required for antenna arrangements. It may be considered that a beam is produced by hybrid beamforming, e.g. by analog beamforming performed on a beam representation or beam formed based on digital beamforming. Monitoring and/or performing cell search may be based on reception beamforming, e.g. analog or digital or hybrid reception beamforming. The numerology may determine the length of a symbol time interval and/or the duration of a cyclic prefix. The approaches described herein are particularly suitable to SC-FDM, to ensure orthogonality, in particular subcarrier orthogonality, in corresponding systems, but may be used for other wave-forms. Communicating may comprise utilising a wave-form with cyclic prefix. The cyclic prefix may be based on a numerology, and may help keeping signalling orthogonal. Communicating may comprise, and/or be based on per-forming cell search, e.g. for a wireless device or terminal, or may comprise transmitting cell identifying signalling and/or a selection indication, based on which a radio node receiving the selection indication may select a signalling bandwidth from a set of signalling bandwidths for performing cell search.

A beam or beam pair may in general be targeted at one radio node, or a group of radio nodes and/or an area including one or more radio nodes. In many cases, a beam or beam pair may be receiver-specific (e.g., UE-specific), such that only one radio node is served per beam/beam pair. A beam pair switch or switch of received beam (e.g., by using a different reception beam) and/or transmission beam may be performed at a border of a transmission timing structure, e.g. a slot border, or within a slot, for example between symbols. Some tuning of radio circuitry, e.g. for receiving and/or transmitting, may be performed. Beam pair switching may comprise switching from a second received beam to a first received beam, and/or from a second transmission beam to a first transmission beam. Switching may comprise inserting a guard period to cover retuning time; however, circuitry may be adapted to switch sufficiently quickly to essentially be instantaneous; this may in particular be the case when digital reception beamforming is used to switch reception beams for switching received beams.

A reference beam (or reference signalling beam) may be a beam comprising reference signalling, based on which for example a of beam signalling characteristics may be deter-mined, e.g. measured and/or estimated. A signalling beam may comprise signalling like control signalling and/or data signalling and/or reference signalling. A reference beam may be transmitted by a source or transmitting radio node, in which case one or more beam signalling characteristics may be reported to it from a receiver, e.g. a wireless de-vice. However, in some cases it may be received by the radio node from another radio node or wireless device. In this case, one or more beam signalling characteristics may be determined by the radio node. A signalling beam may be a transmission beam, or a reception beam. A set of signalling characteristics may comprise a plurality of subsets of beam signalling characteristics, each subset pertaining to a different reference beam. Thus, a reference beam may be associated to different beam signalling characteristics.

A beam signalling characteristic, respectively a set of such characteristics, may represent and/or indicate a signal strength and/or signal quality of a beam and/or a delay characteristic and/or be associated with received and/or measured signalling carried on a beam. Beam signalling characteristics and/or delay characteristics may in particular pertain to, and/or indicate, a number and/or list and/or order of beams with best (e.g., lowest mean delay and/or lowest spread/range) timing or delay spread, and/or of strongest and/or best quality beams, e.g. with associated delay spread. A beam signalling characteristic may be based on measurement/s performed on reference signalling carried on the reference beam it pertains to. The measurement/s may be performed by the radio node, or another node or wireless device. The use of reference signalling allows improved accuracy and/or gauging of the measurements. In some cases, a beam and/or beam pair may be represented by a beam identity indication, e.g. a beam or beam pair number. Such an indication may be represented by one or more signalling sequences (e.g., a specific reference signalling sequences or sequences), which may be transmitted on the beam and/or beam pair, and/or a signalling characteristic and/or a resource/s used (e.g., time/frequency and/or code) and/or a specific RNTI (e.g., used for scrambling a CRC for some messages or transmissions) and/or by information provided in signalling, e.g. control signalling and/or system signalling, on the beam and/or beam pair, e.g. encoded and/or provided in an information field or as information element in some form of message of signalling, e.g. DCI and/or MAC and/or RRC signalling.

A reference beam may in general be one of a set of reference beams, the second set of reference beams being associated to the set of signalling beams. The sets being associated may refer to at least one beam of the first set being associated and/or corresponding to the second set (or vice versa), e.g. being based on it, for example by having the same analog or digital beamforming parameters and/or precoder and/or the same shape before analog beamforming, and/or being a modified form thereof, e.g. by performing additional analog beamforming. The set of signalling beams may be referred to as a first set of beams, a set of corresponding reference beams may be referred to as second set of beams.

In some variants, a reference beam and/or reference beams and/or reference signalling may correspond to and/or carry random access signalling, e.g. a random access preamble. Such a reference beam or signalling may be transmitted by another radio node. The signalling may indicate which beam is used for transmitting. Alternatively, the reference beams may be beams receiving the random access signalling. Random access signalling may be used for initial connection to the radio node and/or a cell provided by the radio node, and/or for reconnection. Utilising random access signalling facilitates quick and early beam selection. The random access signalling may be on a random access channel, e.g. based on broadcast information provided by the radio node (the radio node performing the beam selection), e.g. with synchronisation signalling (e.g., SSB block and/or associated thereto). The reference signalling may correspond to synchronisation signalling, e.g. transmitted by the radio node in a plurality of beams. The characteristics may be reported on by a node receiving the synchronisation signalling, e.g. in a random access process, e.g. a Msg3 for contention resolution, which may be transmitted on a physical uplink shared channel based on a resource allocation provided by the radio node.

A delay characteristic (which may correspond to delay spread information) and/or a measurement report may represent and/or indicate at least one of mean delay, and/or delay spread, and/or delay distribution, and/or delay spread distribution, and/or delay spread range, and/or relative delay spread, and/or energy (or power) distribution, and/or impulse response to received signalling, and/or the power delay profile of the received signals, and/or power delay profile related parameters of the received signal. A mean delay may represent the mean value and/or an averaged value of the delay spread, which may be weighted or unweighted. A distribution may be distribution over time/delay, e.g. of received power and/or energy of a signal. A range may indicate an interval of the delay spread distribution over time/delay, which may cover a predetermined percentage of the delay spread respective received energy or power, e.g. 50% or more, 75% or more, 90% or more, or 100%. A relative delay spread may indicate a relation to a threshold delay, e.g. of the mean delay, and/or a shift relative to an expected and/or configured timing, e.g. a timing at which the signalling would have been expected based on the scheduling, and/or a relation to a cyclic prefix duration (which may be considered on form of a threshold). Energy distribution or power distribution may pertain to the energy or power received over the time interval of the delay spread. A power delay profile may pertain to representations of the received signals, or the received signals energy/power, across time/delay. Power delay profile related parameters may pertain to metrics computed from the power delay profile. Different values and forms of delay spread information and/or report may be used, allowing a wide range of capabilities. The kind of information represented by a measurement report may be predefined, or be configured or configurable, e.g. with a measurement configuration and/or reference signalling configuration, in particular with higher layer signalling like RRC or MAC signalling and/or physical layer signalling like DCI signalling.

In general, different beam pair may differ in at least one beam; for example, a beam pair using a first received beam and a first transmission beam may be considered to be different from a second beam pair using the first received beam and a second transmission beam. A transmission beam using no precoding and/or beamforming, for example using the natural antenna profile, may be considered as a special form of transmission beam of a transmission beam pair. A beam may be indicated to a radio node by a transmitter with a beam indication and/or a configuration, which for example may indicate beam parameters and/or time/frequency resources associated to the beam and/or a transmission mode and/or antenna profile and/or antenna port and/or precoder associated to the beam. Different beams may be provided with different content, for example different received beams may carry different signalling; however, there may be considered cases in which different beams carry the same signalling, for example the same data signalling and/or reference signalling. The beams may be transmitted by the same node and/or transmission point and/or antenna arrangement, or by different nodes and/or transmission points and/or antenna arrangements.

Communicating utilising a beam pair or a beam may comprise receiving signalling on a received beam (which may be a beam of a beam pair), and/or transmitting signalling on a beam, e.g. a beam of a beam pair. The following terms are to be interpreted from the point of view of the referred radio node: a received beam may be a beam carrying signalling received by the radio node (for reception, the radio node may use a reception beam, e.g. directed to the received beam, or be non-beamformed). A transmission beam may be a beam used by the radio node to transmit signalling. A beam pair may consist of a received beam and a transmission beam The transmission beam and the received beam of a beam pair may be associated to each and/or correspond to each other, e.g. such that signalling on the received beam and signalling on a transmission beam travel essentially the same path (but in opposite directions), e.g. at least in a stationary or almost stationary condition. It should be noted that the terms “first” and “second” do not necessarily denote an order in time; a second signalling may be received and/or transmitted before, or in some cases simultaneous to, first signalling, or vice versa. The received beam and transmission beam of a beam pair may be on the same carrier or frequency range or bandwidth part, e.g. in a TDD operation; however, variants with FDD may be considered as well. Different beam pairs may operate on the same frequency ranges or carriers or bandwidth parts (e.g., such that transmission beams operate on the same frequency range or carriers or bandwidth part, and received beams on the same frequency range or carriers or bandwidth part (the transmission beam and received beams may be on the same or different ranges or carriers or BWPs). Communicating utilizing a first beam pair and/or first beam may be based on, and/or comprise, switching from the second beam pair or second beam to the first beam pair or first beam for communicating. The switching may be controlled by the network, for example a network node (which may be the source or transmitter of the received beam of the first beam pair and/or second beam pair, or be associated thereto, for example associated transmission points or nodes in dual connectivity). Such controlling may comprise transmitting control signalling, e.g. physical layer signalling and/or higher layer signalling. In some cases, the switching may be performed by the radio node without additional control signalling, for example based on measurements on signal quality and/or signal strength of beam pairs (e.g., of first and second received beams), in particular the first beam pair and/or the second beam pair. For example, it may be switched to the first beam pair (or first beam) if the signal quality or signal strength measured on the second beam pair (or second beam) is considered to be insufficient, and/or worse than corresponding measurements on the first beam pair indicate. Measurements performed on a beam pair (or beam) may in particular comprise measurements performed on a received beam of the beam pair. It may be considered that the timing indication may be determined before switching from the second beam pair to the first beam pair for communicating. Thus, the synchronization may be in place and/or the timing indication may be available for synchronising) when starting communication utilizing the first beam pair or first beam. However, in some cases the timing indication may be determined after switching to the first beam pair or first beam. This may be in particular useful if first signalling is expected to be received after the switching only, for example based on a periodicity or scheduled timing of suitable reference signalling on the first beam pair, e.g. first received beam. In general, a reception beam of a node may be associated to and/or correspond to a transmission beam of the node, e.g. such that the (spatial) angle of reception of the reception beam and the (spatial) angle of transmission of the transmission beam at least partially, or essentially or fully, overlap and/or coincide, in particular for TDD operation and/or independent of frequency. Spatial correspondence between beams may be considered in some cases, e.g. such that a beam pair (e.g., transmission beam of a transmitting node and reception beam of a receiving node) may be considered to comprise corresponding beams (e.g., the reception beam is suitable and/or the best beam to receive transmissions on the transmission beam, e.g. based on a threshold signal quality and/or signal strength and/or measurements); to each of such beams, there may be an associated or corresponding complementary beam of the respective node (e.g., to a transmission beam of a beam pair, there may be associated a reception beam of the transmitting node, and/or to the reception beam of a beam pair, there may be associated a transmitting beam of the receiving node; if the beams (e.g., at least essentially or substantially) overlap (e.g., in spatial angle), in some cases a beam pair may be considered to indicate four beams (or actually, two beam pairs).

In some cases, to one or more beams or signals or signallings may be associated a Quasi-CoLocation (QCL) characteristic or set of characteristics, or QCL class (also referred to as QCL type) or QCL identity; beams or signal or signallings sharing such may be considered to be Quasi-Colocated. Quasi-Colocated beams or signals or signallings may be considered (e.g., by a receiver) as the same beam or originating from the same transmit-ter or transmission source, at least in regard to the QCL characteristic or set or class or identity, and/or to share the characteristic/s. QCL characteristics may pertain to propagation of signalling, and/or one or more delay characteristics, and/or pathloss, and/or signal quality, and/or signal strength, and/or beam direction, and/or beam shape (in particular, angle or area, e.g. area of coverage), and/or Doppler shift, and/or Doppler spread, and/or delay spread, and/or time synchronisation, and/or frequency synchronisation, and/or one or more other parameters, e.g. pertaining to a propagation channel and/or spatial RX parameter/s (which may refer to reception beam and/or transmission beam, e.g. shape or coverage or direction). A QCL characteristic may pertain to a specific channel (e.g., physical layer channel like a control channel or data channel) and/or reference signalling type and/or antenna port. Different QCL classes or types may pertain to different QCL characteristics or sets of characteristics; a QCL class may define and/or pertain to one or more criteria and/or thresholds and/or ranges for one or more QCL characteristics beams have to fulfill to be considered Quasi-Colocated according to this class; a QCL identity may refer to and/or represent all beams being quasi-colocated, according to a QCL class. Different classes may pertain to one or more of the same characteristics (e.g., different classes may have different criteria and/or thresholds and/or ranges for one or more characteristics) and/or to different characteristics. A QCL indication may be seen as a form of beam indication, e.g. pertaining to all beams belonging to one QCL class and/or QCL identity and/or quasi-colocated beams. A QCL identity may be indicated by a QCL indication. In some cases, a beam, and/or a beam indication, may be considered to refer and/or represent a to a QCL identity, and/or to represent quasi-colocated beams or signals or signallings.

Transmission on multiple layers (multi-layer transmission) may refer to transmission of communication signalling and/or reference signalling simultaneously in one or more beams and/or using a plurality of transmission sources, e.g. controlled by one network node or one wireless device. The layers may refer to layers of transmission; a layer may be considered to represent one data or signalling stream. Different layers may carry different data and/or data streams, e.g., to increase data throughput. In some cases, the same data or data stream may be transported on different layers, e.g. to increase reliability. Multi-layer transmission may provide diversity, e.g. transmission diversity and/or spatial diversity. It may be considered that multi-layer transmission comprises 2, or more than 2 layers; the number of layers of transmission may be represented by a rank or rank indication.

A transmission source may in particular comprise, and/or be represented by, and/or associated to, an antenna or group of antenna elements or antenna sub-array or antenna array or transmission point or TRP or TP (Transmission Point) or access point. In some cases, a transmission source may be represented or representable, and/or correspond to, and/or associated to, an antenna port or layer of transmission, e.g. for multi-layer transmission. Different transmission sources may in particular comprise different and/or separately controllable antenna element/s or (sub-)arrays and/or be associated to different antenna ports. In particular, analog beamforming may be used, with separate analog control of the different transmission sources. An antenna port may indicate a transmission source, and/or a one or more transmission parameter, in particular of reference signalling associated to the antenna port. In particular, transmission parameters pertaining to, and/or indicating a frequency domain distribution or mapping (e.g., which comb to use and/or which subcarrier or frequency offset to use, or similar) of modulation symbols of the reference signalling, and/or to which cyclic shift to use (e.g., to shift elements of a modulation symbol sequence, or a root sequence, or a sequence based on or derived from the root sequence) and/or to which cover code to use (e.g., (e.g., to shift elements of a modulation symbol sequence, or a root sequence, or a sequence based on or derived from the root sequence). In some cases, a transmission source may represent a target for reception, e.g. if it is implemented as a TRP or AP (Access Point).

In some variants, reference signalling may be and/or comprise CSI-RS and/or PT-RS and/or DMRS, e.g. transmitted by the network node. In other variants, the reference signalling may be transmitted by a UE, e.g. to a network node or other UE, in which case it may comprise and/or be Sounding Reference signalling. Other, e.g. new, forms of reference signalling may be considered and/or used. In general, a modulation symbol of reference signalling respectively a resource element carrying it may be associated to a cyclic prefix.

Data signalling may be on a data channel, for example on a PDSCH or PSSCH, or on a dedicated data channel, e.g. for low latency and/or high reliability, e.g. a URLLC channel. Control signalling may be on a control channel, for example on a common control channel or a PDCCH or PSCCH, and/or comprise one or more DCI messages or SCI messages. Reference signalling may be associated to control signalling and/or data signalling, e.g. DM-RS and/or PT-RS.

Reference signalling, for example, may comprise DM-RS and/or pilot signalling and/or discovery signalling and/or synchronisation signalling and/or sounding signalling and/or phase tracking signalling and/or cell-specific reference signalling and/or user-specific signalling, in particular CSI-RS. Reference signalling in general may be signalling with one or more signalling characteristics, in particular transmission power and/or sequence of modulation symbols and/or resource distribution and/or phase distribution known to the receiver. Thus, the receiver can use the reference signalling as a reference and/or for training and/or for compensation. The receiver can be informed about the reference signalling by the transmitter, e.g. being configured and/or signalling with control signalling, in particular physical layer signalling and/or higher layer signalling (e.g., DCI and/or RRC signalling), and/or may determine the corresponding information itself, e.g. a network node configuring a UE to transmit reference signalling. Reference signalling may be signalling comprising one or more reference symbols and/or structures. Reference signalling may be adapted for gauging and/or estimating and/or representing transmission conditions, e.g. channel conditions and/or transmission path conditions and/or channel (or signal or transmission) quality. It may be considered that the transmission characteristics (e.g., signal strength and/or form and/or modulation and/or timing) of reference signalling are available for both transmitter and receiver of the signalling (e.g., due to being predefined and/or configured or configurable and/or being communicated). Different types of reference signalling may be considered, e.g. pertaining to uplink, downlink or sidelink, cell-specific (in particular, cell-wide, e.g., CRS) or device or user specific (addressed to a specific target or user equipment, e.g., CSI-RS), demodulation-related (e.g., DMRS) and/or signal strength related, e.g. power-related or energy-related or amplitude-related (e.g., SRS or pilot signalling) and/or phase-related, etc.

References to specific resource structures like an allocation unit and/or block symbol and/or block symbol group and/or transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), sub-frame, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4, or more symbols, e.g. less symbols than symbols in a slot. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

A transmission quality parameter may in general correspond to the number R of retransmissions and/or number T of total transmissions, and/or coding (e.g., number of coding bits, e.g. for error detection coding and/or error correction coding like FEC coding) and/or code rate and/or BLER and/or BER requirements and/or transmission power level (e.g., minimum level and/or target level and/or base power level PO and/or transmission power control command, TPC, step size) and/or signal quality, e.g. SNR and/or SIR and/or SINR and/or power density and/or energy density.

A signalling sequence or sequence (e.g. of an allocation unit or block symbol or symbol time interval, and/or carried or transmitted on an allocation unit or block symbol or symbol time interval) may be based on a sequence root, e.g. a root sequence and/or a root parameter and/or root index and/or seed. A sequence root in general may represent or indicate a base for deriving or determining a signalling sequence; the root may be associated to, and/or represent a sequence directly, and/or indicate or represent a base sequence and/or seed. Examples of sequence roots may comprise a Zadoff Chu root sequence, a sequence seed, e.g. a seed for a Gold sequence, or a Golay complimentary sequence. A signalling sequence may be derived or derivable from, and/or be based on, a sequency root, e. g. based on a code, which may represent a shift or operation or processing on the root sequence or a sequence indicated by the sequence root, e.g. to provide the signalling sequence; the signalling sequence may be based on such shifted or processed or operated on root sequence. The code may in particular represent a cyclic shift and/or phase shift and/or phase ramp (e.g., an amount for such). The code may assign one operation or shift for each allocation unit.

In general, a signalling sequence associated to an allocation unit (and/or the allocation units) associated to control signalling (and/or reference signalling) may be based on a root sequence which may be a M-sequence or Zadoff-Chu sequence, or a Gold or Golay sequence, or another sequence with suitable characteristics regarding correlation and/or interference (e.g., self-interference and/or interference with other or neighboring transmitters). Different sequences may be used as root sequences for different signalling sequences, or the same sequence may be used. If different sequences are used, they may be of the same type (Gold, Golay, M- or Zadoff-Chu, for example). The (signalling and/or root) sequences may correspond to or be time-domain sequences, e.g. time domain Zadoff-Chu and/or time-domain M sequences.

In some cases, a shifted object like a signalling or signals or sequences or information may be shifted, e.g. relative to a predecessor (e.g., one is subject to a shift, and the shifted version is used), or relative to another (e.g., one associated to one signalling or allocation unit may be shifted to another associated to a second signalling or allocation unit, both may be used). One possible way of shifting is operating a code on it, e.g. to multiply each element of a shifting object with a factor. A ramping (e.g. multiplying with a monotonously increasing or periodic factor) may be considered an example of shifting. Another is a cyclic shift in a domain or interval. A cyclic shift (or circular shift) may correspond to a rearrangement of the elements in the shifting object, corresponding to moving the final element or elements to the first position, while shifting all other entries to the next position, or by performing the inverse operation (such that the shifted object as the result will have the same elements as the shifting object, in a shifted but similar order). Shifting in general may be specific to an interval in a domain, e.g. an allocation unit in time domain, or a bandwidth in frequency domain. For example, it may be considered that signals or modulation symbol in an allocation unit are shifted, such that the order of the modulation symbols or signals is shifted in the allocation unit. In another example, allocation units may be shifted, e.g. in a larger time interval—this may leave signals in the allocation units unshifted with reference to the individual allocation unit, but may change the order of the allocation units. Domains for shifting may for example be time domain and/or phase domain and/or frequency domain. Multiple shifts in the same domain or different domains, and/or the same interval or different intervals (differently sized intervals, for example) may be performed.

Reference signalling may have a type. Types of reference signalling may include synchronisation signalling, and/or DM-RS (used to facilitate demodulation of associated data signalling and/or control signalling), and/or PT-RS (used to facilitate phase tracking of associated data signalling and/or control signalling, e.g. within a time interval or symbol or allocation unit carrying such signalling), and/or CSI-RS (e.g., used for channel estimation and/or reporting). It may be considered that PT-RS are inserted into a bit sequence, or a modulation symbol sequence, which may represent data. For example, PT-RS may be mapped onto subcarriers of a symbol also carrying data symbols. Accordingly, PT-RS insertion may be optimised for hardware implementations. In some cases, PT-RS may be modulated differently and/or independently of the modulation symbols representing data (or data bits).

A comb structure, or shorter comb, may indicate a distribution, or periodic arrangement of reference signalling, in particular in frequency space, e.g. between an upper and lower frequency. A comb may pertain to one OFDMA symbol and/or SC-FDMA symbol and/or one (the same) symbol time interval and/or one allocation unit. A comb may have width or size N and/or may pertain to, and/or be associated to, specific signalling and/or a type of signalling, e.g. a type of reference signalling. The width N may indicate how many empty subcarriers are between (e.g., non-neighbouring) subcarriers carrying an element or signal or symbol of the signalling (e.g., this number may be N−1), or how many empty subcarriers and non-empty subcarriers form a pattern that is repeated in frequency domain. In general, each comb may indicate that at least one empty subcarrier is to be between non-empty subcarriers. In this context, empty may refer to empty regarding the pattern or distribution of the signalling associated to the comb (and non-empty may refer to a subcarrier carrying an element or symbol of the associated signalling); in some cases, other signallings (which may have a comb structure as well) may be carried on empty subcarriers, e.g. transmitted using other transmission sources and/or other devices, and/or mapped into the comb (e.g., for a DMRS comb, data signalling may be mapped on subcarriers not carrying DMRS).

A comb structure may generally describe a structure in which for every N-th (N may be an integer) resource element and/or subcarrier a reference signal or an element of a sequence of the reference signalling, and/or representing the reference signalling, and/or on which the reference signalling is based, is mapped to, and/or represented by signalling the resource element and/or subcarrier, in particular an element (symbol) of a modulation symbol sequence, or an element of a sequence. N may be called the width of the comb. Generally, the comb may indicate the periodicity of the pattern inside the frequency range of the reference signalling. The pattern may in particular pertain to one reference signal and/or resource element or subcarrier for transmitting a reference signal, such that the comb may be considered to indicate that on every Nth resource element (in particular, only there) and/or subcarrier there is to be a reference signal or element of an associated sequence, and/or how many resource elements and/or subcarriers are between resource elements and/or subcarriers with reference signals. However, there may be considered variants, in which the pattern represents more than one reference signals. The pattern may also generally represent and/or indicate one or more empty signals and/or one or more data signals (respectively associated resource elements and/or subcarriers). For each comb or comb structure with a width or size of N, there may be N or f (N) different available individual combs. For example, for N=2, there may be two combs shifted in frequency space by one, or an odd number, of subcarriers or PRBs (e.g., based on a frequency domain offset, or a subcarrier offset). A comb structure or comb of width or size of N may be indicated as N-comb. Specific combs of this width may be numbered within N. For example, for a 2-comb, there may be a comb 1 (or C1) and a comb 2 (or C2), which may be shifted relative to each other, e.g. to dovetail such that all subcarrier covered by both combs carry signalling (associated to C1 and C2 alternatingly in frequency domain).

A comb may comprise two or more, for example at least three or at least four, repetitions of the pattern. The comb may indicate a reference and/or indication, e.g. a resource element and/or subcarrier, which may be related to the upper and/or lower boundary in frequency, regarding the arrangement and/or location in frequency of a first pattern, and/or the relative shift of the pattern and/or comb in frequency. Generally, a comb structure may cover at least part, and/or at least the majority, and/or essentially all or all resource elements and/or subcarriers of the plurality of resource elements and/or subcarriers, and/or the symbol. A comb structure may result from combining two comb structures, which may in particular comb structures with pattern comprising only one reference signal. A comb structure may be determined and/or amended before transmission, e.g. based on other reference signalling to be transmitted, e.g. on a different antenna port. In this context, reference signals may be replaced by empty signals to avoid overlap and/or interference. Generally, if the other reference signalling utilises a comb structure as well, a different/new comb (as a combination of combs) may be considered to be determined, e.g. with less dense reference signal distribution and/or a different/wider pattern. Alternatively, or additionally, combs may be combined to increase the reference signal density, e.g. by combining combs with different widths, and/or with shifted offsets.

Generally, a comb structure may represent and/or comprise and/or be comprised of any of the combs/comb structures described herein.

A buffer state report (or buffer status report, BSR) may comprise information representing the presence and/or size of data to be transmitted (e.g., available in one or more buffers, for example provided by higher layers). The size may be indicated explicitly, and/or indexed to range/s of sizes, and/or may pertain to one or more different channel/s and/or acknowledgement processes and/or higher layers and/or channel groups/s, e.g, one or more logical channel/s and/or transport channel/s and/or groups thereof: The structure of a BSR may be predefined and/or configurable of configured, e.g. to override and/or amend a predefined structure, for example with higher layer signalling, e.g. RRC signalling. There may be different forms of BSR with different levels of resolution and/or information, e.g. a more detailed long BSR and a less detailed short BSR. A short BSR may concatenate and/or combine information of a long BSR, e.g. providing sums for data available for one or more channels and/or or channels groups and/or buffers, which might be represented individually in a long BSR; and/or may index a less-detailed range scheme for data available or buffered. A BSR may be used in lieu of a scheduling request, e.g. by a network node scheduling or allocating (uplink) resources for the transmitting radio node like a wireless device or UE or IAB node.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprises the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A system comprising one or more radio nodes as described herein, in particular a network node and a user equipment, is described. The system may be a wireless communication system, and/or provide and/or represent a radio access network.

Moreover, there may be generally considered a method of operating an information system, the method comprising providing information. Alternatively, or additionally, an information system adapted for providing information may be considered. Providing in-formation may comprise providing information for, and/or to, a target system, which may comprise and/or be implemented as radio access network and/or a radio node, in particular a network node or user equipment or terminal. Providing information may comprise transferring and/or streaming and/or sending and/or passing on the information, and/or offering the information for such and/or for download, and/or triggering such providing, e.g. by triggering a different system or node to stream and/or transfer and/or send and/or pass on the information. The information system may comprise, and/or be connected or connectable to, a target, for example via one or more intermediate systems, e.g. a core network and/or internet and/or private or local network. Information may be provided utilising and/or via such intermediate system/s. Providing information may be for radio transmission and/or for transmission via an air interface and/or utilising a RAN or radio node as described herein. Connecting the information system to a target, and/or providing information, may be based on a target indication, and/or adaptive to a target indication. A target indication may indicate the target, and/or one or more parameters of transmission pertaining to the target and/or the paths or connections over which the in-formation is provided to the target. Such parameter/s may in particular pertain to the air interface and/or radio access network and/or radio node and/or network node. Example parameters may indicate for example type and/or nature of the target, and/or transmission capacity (e.g., data rate) and/or latency and/or reliability and/or cost, respectively one or more estimates thereof. The target indication may be provided by the target, or determined by the information system, e.g. based on information received from the target and/or historical information, and/or be provided by a user, for example a user operating the target or a device in communication with the target, e.g. via the RAN and/or air interface. For example, a user may indicate on a user equipment communicating with the information system that information is to be provided via a RAN, e.g. by selecting from a selection provided by the information system, for example on a user application or user interface, which may be a web interface. An information system may comprise one or more information nodes. An information node may generally comprise processing 46 circuitry and/or communication circuitry. In particular, an information system and/or an information node may be implemented as a computer and/or a computer arrangement, e.g. a host computer or host computer arrangement and/or server or server arrangement. In some variants, an interaction server (e.g., web server) of the information system may provide a user interface, and based on user input may trigger transmitting and/or streaming information provision to the user (and/or the target) from another server, which may be connected or connectable to the interaction server and/or be part of the information system or be connected or connectable thereto. The information may be any kind of data, in particular data intended for a user of for use at a terminal, e.g. video data and/or audio data and/or location data and/or interactive data and/or game-related data and/or environmental data and/or technical data and/or traffic data and/or vehicular data and/or circumstantial data and/or operational data. The information provided by the information system may be mapped to, and/or mappable to, and/or be intended for mapping to, communication or data signalling and/or one or more data channels as described herein (which may be signalling or channel/s of an air interface and/or used within a RAN and/or for radio transmission). It may be considered that the information is formatted based on the target indication and/or target, e.g. regarding data amount and/or data rate and/or data structure and/or timing, which in particular may be pertaining to a mapping to communication or data signalling and/or a data channel. Mapping information to data signalling and/or data channel/s may be considered to refer to using the signalling/channel/s to carry the data, e.g. on higher layers of communication, with the signalling/channel/s underlying the transmission. A target indication generally may comprise different components, which may have different sources, and/or which may indicate different characteristics of the target and/or communication path/s thereto. A format of information may be specifically selected, e.g. from a set of different formats, for information to be transmitted on an air interface and/or by a RAN as described herein. This may be particularly pertinent since an air interface may be limited in terms of capacity and/or of predictability, and/or potentially be cost sensitive. The format may be selected to be adapted to the transmission indication, which may in particular indicate that a RAN or radio node as described herein is in the path (which may be the indicated and/or planned and/or expected path) of information between the target and the information system. A (communication) path of information may represent the interface/s (e.g., air and/or cable interfaces) and/or the intermediate system/s (if any), between the information system and/or the node providing or transferring the information, and the target, over which the information is, or is to be, passed on. A path may be (at least partly) undetermined when a target indication is provided, and/or the information is provided/transferred by the information system, e.g. if an internet is involved, which may comprise multiple, dynamically chosen paths. Information and/or a format used for information may be packet-based, and/or be mapped, and/or be mappable and/or be intended for mapping, to packets. Alternatively, or additionally, there may be considered a method for operating a target device comprising providing a target indicating to an information system. More alternatively, or additionally, a target device may be considered, the target device being adapted for providing a target indication to an information system. In another approach, there may be considered a target indication tool adapted for, and/or comprising an indication module for, providing a target indication to an information system. The target device may generally be a target as described above. A target indication tool may comprise, and/or be implemented as, software and/or application or app, and/or web interface or user interface, and/or may comprise one or more modules for implementing actions performed and/or controlled by the tool. The tool and/or target device may be adapted for, and/or the method may comprise, receiving a user input, based on which a target indicating may be determined and/or provided. Alternatively, or additionally, the tool and/or target device may be adapted for, and/or the method may comprise, receiving information and/or communication signalling carrying information, and/or operating on, and/or presenting (e.g., on a screen and/or as audio or as other form of indication), information. The information may be based on received information and/or communication signalling carrying information. Presenting information may comprise processing received information, e.g. decoding and/or transforming, in particular between different formats, and/or for hardware used for presenting. Operating on information may be independent of or without presenting, and/or proceed or succeed presenting, and/or may be without user interaction or even user reception, for example for automatic processes, or target devices without (e.g., regular) user interaction like MTC devices, of for automotive or transport or industrial use. The information or communication signalling may be expected and/or received based on the target indication. Presenting and/or operating on information may generally comprise one or more processing steps, in particular decoding and/or executing and/or interpreting and/or transforming information. Operating on information may generally comprise relaying and/or transmitting the information, e.g. on an air interface, which may include mapping the information onto signalling (such mapping may generally pertain to one or more layers, e.g. one or more layers of an air interface, e.g. RLC (Radio Link Control) layer and/or MAC layer and/or physical layer/s). The information may be imprinted (or mapped) on communication signalling based on the target indication, which may make it particularly suitable for use in a RAN (e.g., for a target device like a network node or in particular a UE or terminal). The tool may generally be adapted for use on a target device, like a UE or terminal. Generally, the tool may provide multiple functionalities, e.g. for providing and/or selecting the target indication, and/or presenting, e.g. video and/or audio, and/or operating on and/or storing received information. Providing a target indication may comprise transmitting or transferring the indication as signalling, and/or carried on signalling, in a RAN, for example if the target device is a UE, or the tool for a UE. It should be noted that such provided information may be transferred to the information system via one or more additionally communication interfaces and/or paths and/or connections. The target indication may be a higher-layer indication and/or the information provided by the information system may be higher-layer information, e.g. application layer or user-layer, in particular above radio layers like transport layer and physical layer. The target indication may be mapped on physical layer radio signalling, e.g. related to or on the user-plane, and/or the information may be mapped on physical layer radio communication signalling, e.g. related to or on the user-plane (in particular, in reverse communication directions). The described approaches allow a target indication to be provided, facilitating information to be provided in a specific format particularly suitable and/or adapted to efficiently use an air interface. A user input may for example represent a selection from a plurality of possible transmission modes or formats, and/or paths, e.g. in terms of data rate and/or packaging and/or size of information to be provided by the information system.

In general, a numerology and/or subcarrier spacing may indicate the bandwidth (in frequency domain) of a subcarrier of a carrier, and/or the number of subcarriers in a carrier and/or the numbering of the subcarriers in a carrier, and/or the symbol time length. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths, even on the same carrier.

signalling may generally comprise one or more (e.g., modulation) symbols and/or signals and/or messages. A signal may comprise or represent one or more bits. An indication may represent signalling, and/or be implemented as a signal, or as a plurality of signals. One or more signals may be included in and/or represented by a message. signalling, in particular control signalling, may comprise a plurality of signals and/or messages, which may be transmitted on different carriers and/or be associated to different signalling processes, e.g. representing and/or pertaining to one or more such processes and/or corresponding information. An indication may comprise signalling, and/or a plurality of signals and/or messages and/or may be comprised therein, which may be transmitted on different carriers and/or be associated to different acknowledgement signalling processes, e.g. representing and/or pertaining to one or more such processes. signalling associated to a channel may be transmitted such that represents signalling and/or information for that channel, and/or that the signalling is interpreted by the transmitter and/or receiver to belong to that channel. Such signalling may generally comply with transmission parameters and/or format/s for the channel.

An antenna arrangement may comprise one or more antenna elements (radiating elements), which may be combined in antenna arrays. An antenna array or sub-array may comprise one antenna element, or a plurality of antenna elements, which may be arranged e.g. two dimensionally (for example, a panel) or three dimensionally. It may be considered that each antenna array or sub-array or element is separately controllable, respectively that different antenna arrays are controllable separately from each other. A single antenna element/radiator may be considered the smallest example of a sub-array. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g. a configuring or informing or scheduling radio node, e.g. to be controlled or controllable by the radio node. An antenna arrangement associated to a UE or terminal may be smaller (e.g., in size and/or number of antenna elements or arrays) than the antenna arrangement associated to a network node. Antenna elements of an antenna arrangement may be configurable for different arrays, e.g. to change the beamforming characteristics. In particular, antenna arrays may be formed by combining one or more independently or separately controllable antenna elements or sub-arrays. The beams may be provided by analog beamforming, or in some variants by digital beamforming, or by hybrid beamforming combing analog and digital beamforming. The informing radio nodes may be configured with the manner of beam transmission, e.g. by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (analog-Digital-Converter, alternatively an ADC chain) or DCA (Digital-to-analog Converter, alternatively a DCA chain) to convert digital control information into an analog antenna feed for the whole antenna arrangement (the ADC/DCA may be considered part of, and/or connected or connectable to, antenna circuitry) or vice versa. A scenario in which an ADC or DCA is controlled directly for beamforming may be considered an analog beamforming scenario; such controlling may be performed after encoding/decoding and/or after modulation symbols have been mapped to resource elements. This may be on the level of antenna arrangements using the same ADC/DCA, e.g. one antenna element or a group of antenna elements associated to the same ADC/DCA. Digital beamforming may correspond to a scenario in which processing for beamforming is provided before feeding signalling to the ADC/DCA, e.g. by using one or more precoder/s and/or by precoding information, for example before and/or when mapping modulation symbols to resource elements. Such a precoder for beamforming may provide weights, e.g. for amplitude and/or phase, and/or may be based on a (precoder) codebook, e.g. selected from a codebook. A precoder may pertain to one beam or more beams, e.g. defining the beam or beams. The codebook may be configured or configurable, and/or be predefined. DFT beamforming may be considered a form of digital beamforming, wherein a DFT procedure is used to form one or more beams. Hybrid forms of beamforming may be considered.

A beam may be defined by a spatial and/or angular and/or spatial angular distribution of radiation and/or a spatial angle (also referred to as solid angle) or spatial (solid) angle distribution into which radiation is transmitted (for transmission beamforming) or from which it is received (for reception beamforming). Reception beamforming may comprise only accepting signals coming in from a reception beam (e.g., using analog beamforming to not receive outside reception beam/s), and/or sorting out signals that do not come in in a reception beam, e.g. in digital postprocessing, e.g. digital beamforming. A beam may have a solid angle equal to or smaller than 4*pi sr (4*pi correspond to a beam covering all directions), in particular smaller than 2*pi, or pi, or pi/2, or pi/4 or pi/8 or pi/16. In particular for high frequencies, smaller beams may be used. Different beams may have different directions and/or sizes (e.g., solid angle and/or reach). A beam may have a main direction, which may be defined by a main lobe (e.g., center of the main lobe, e.g. pertaining to signal strength and/or solid angle, which may be averaged and/or weighted to determine the direction), and may have one or more sidelobes. A lobe may generally be defined to have a continuous or contiguous distribution of energy and/or power transmitted and/or received, e.g. bounded by one or more contiguous or contiguous regions of zero energy (or practically zero energy). A main lobe may comprise the lobe with the largest signal strength and/or energy and/or power content. However, sidelobes usually appear due to limitations of beamforming, some of which may carry signals with significant strength, and may cause multi-path effects. A sidelobe may generally have a different direction than a main lobe and/or other side lobes, however, due to reflections a sidelobe still may contribute to transmitted and/or received energy or power. A beam may be swept and/or switched over time, e.g., such that its (main) direction is changed, but its shape (angular/solid angle distribution) around the main direction is not changed, e.g. from the transmitter's views for a transmission beam, or the receiver's view for a reception beam, respectively. Sweeping may correspond to continuous or near continuous change of main direction (e.g., such that after each change, the main lobe from before the change covers at least partly the main lobe after the change, e.g. at least to 50 or 75 or 90 percent). Switching may correspond to switching direction non-continuously, e.g. such that after each change, the main lobe from before the change does not cover the main lobe after the change, e.g. at most to 50 or 25 or 10 percent.

Signal strength may be a representation of signal power and/or signal energy, e.g. as seen from a transmitting node or a receiving node. A beam with larger strength at transmission (e.g., according to the beamforming used) than another beam does may not necessarily have larger strength at the receiver, and vice versa, for example due to interference and/or obstruction and/or dispersion and/or absorption and/or reflection and/or attrition or other effects influencing a beam or the signalling it carries. Signal quality may in general be a representation of how well a signal may be received over noise and/or interference. A beam with better signal quality than another beam does not necessarily have a larger beam strength than the other beam. Signal quality may be represented for example by SIR, SNR, SINR, BER, BLER, Energy per resource element over noise/interference or another corresponding quality measure. Signal quality and/or signal strength may pertain to, and/or may be measured with respect to, a beam, and/or specific signalling carried by the beam, e.g. reference signalling and/or a specific channel, e.g. a data channel or control channel. Signal strength may be represented by received signal strength, and/or relative signal strength, e.g. in comparison to a reference signal (strength).

Uplink or sidelink signalling may be OFDMA (Orthogonal Frequency Division Multiple Access) or SC-FDMA (Single Carrier Frequency Division Multiple Access) signalling. Downlink signalling may in particular be OFDMA signalling. However, signalling like communication signalling is not limited thereto (Filter-Bank based signalling and/or Single-Carrier based signalling, e.g. SC-FDE signalling, may be considered alternatives).

A radio node may generally be considered a device or node adapted for wireless and/or radio (and/or millimeter wave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or other node, in particular for a RAN or other wireless communication network as described herein.

The terms user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary. A wireless device generally may comprise, and/or be implemented as, processing circuitry and/or radio circuitry, which may comprise one or more chips or sets of chips. The circuitry and/or circuitries may be packaged, e.g. in a chip housing, and/or may have one or more physical interfaces to interact with other circuitry and/or for power supply. Such a wireless device may be intended for use in a user equipment or terminal.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, an RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air inter-face/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A wireless communication network may be or comprise a radio access network and/or a backhaul network (e.g. a relay or backhaul network or an IAB network), and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g. a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Control information or a control information message or corresponding signalling (control signalling) may be transmitted on a control channel, e.g. a physical control channel, which may be a downlink channel or (or a sidelink channel in some cases, e.g. one UE scheduling another UE). For example, control information/allocation information may be signaled by a network node on PDCCH (Physical Downlink Control Channel) and/or a PDSCH (Physical Downlink Shared Channel) and/or a HARQ-specific channel. Acknowledgement signalling, e.g. as a form of control information or signalling like uplink control information/signalling, may be transmitted by a terminal on a PUCCH (Physical Uplink Control Channel) and/or PUSCH (Physical Uplink Shared Channel) and/or a HARQ-specific channel. Multiple channels may apply for multi-component/multi-carrier indication or signalling.

Transmitting acknowledgement signalling may in general be based on and/or in response to subject transmission, and/or to control signalling scheduling subject transmission. Such control signalling and/or subject signalling may be transmitted by a signalling radio node (which may be a network node, and/or a node associated to it, e.g. in a dual connectivity scenario. Subject transmission and/or subject signalling may be transmission or signalling to which ACK/NACK or acknowledgement information pertains, e.g. indicating correct or incorrect reception and/or decoding of the subject transmission or signalling. Subject signalling or transmission may in particular comprise and/or be represented by data signalling, e.g. on a PDSCH or PSSCH, or some forms of control signalling, e.g. on a PDCCH or PSSCH, for example for specific formats.

A signalling characteristic may be based on type or format of a scheduling grant and/or scheduling assignment, and/or type of allocation, and/or timing of acknowledgement signalling and/or the scheduling grant and/or scheduling assignment, and/or resources associated to acknowledgement signalling and/or the scheduling grant and/or scheduling assignment. For example, if a specific format for a scheduling grant (scheduling or allocating the allocated resources) or scheduling assignment (scheduling the subject transmission for acknowledgement signalling) is used or detected, the first or second communication resource may be used. Type of allocation may pertain to dynamic allocation (e.g., using DCI/PDCCH) or semi-static allocation (e.g., for a configured grant). Timing of acknowledgement signalling may pertain to a slot and/or symbol/s the signalling is to be transmitted. Resources used for acknowledgement signalling may pertain to the allocated resources. Timing and/or resources associated to a scheduling grant or assignment may represent a search space or CORESET (a set of resources configured for reception of PDCCH transmissions) in which the grant or assignment is received. Thus, which transmission resource to be used may be based on implicit conditions, requiring low signalling overhead.

Scheduling may comprise indicating, e.g. with control signalling like DCI or SCI signalling and/or signalling on a control channel like PDCCH or PSCCH, one or more scheduling opportunities of a configuration intended to carry data signalling or subject signalling. The configuration may be represented or representable by, and/or correspond to, a table. A scheduling assignment may for example point to an opportunity of the reception allocation configuration, e.g. indexing a table of scheduling opportunities. In some cases, a reception allocation configuration may comprise 15 or 16 scheduling opportunities. The configuration may in particular represent allocation in time. It may be considered that the reception allocation configuration pertains to data signalling, in particular on a physical data channel like PDSCH or PSSCH. In general, the reception allocation configuration may pertain to downlink signalling, or in some scenarios to sidelink signalling. Control signalling scheduling subject transmission like data signalling may point and/or index and/or refer to and/or indicate a scheduling opportunity of the reception allocation configuration. It may be considered that the reception allocation configuration is configured or configurable with higher-layer signalling, e.g. RRC or MAC layer signalling. The reception allocation configuration may be applied and/or applicable and/or valid for a plurality of transmission timing intervals, e.g. such that for each interval, one or more opportunities may be indicated or allocated for data signalling. These approaches allow efficient and flexible scheduling, which may be semi-static, but may updated or reconfigured on useful timescales in response to changes of operation conditions.

Control information, e.g., in a control information message, in this context may in particular be implemented as and/or represented by a scheduling assignment, which may indicate subject transmission for feedback (transmission of acknowledgement signalling), and/or reporting timing and/or frequency resources and/or code resources. Reporting timing may indicate a timing for scheduled acknowledgement signalling, e.g. slot and/or symbol and/or resource set. Control information may be carried by control signalling.

Subject transmissions may comprise one or more individual transmissions. Scheduling assignments may comprise one or more scheduling assignments. It should generally be noted that in a distributed system, subject transmissions, configuration and/or scheduling may be provided by different nodes or devices or transmission points. Different subject transmissions may be on the same carrier or different carriers (e.g., in a carrier aggregation), and/or same or different bandwidth parts, and/or on the same or different layers or beams, e.g. in a MIMO scenario, and/or to same or different ports. Generally, subject transmissions may pertain to different HARQ or ARQ processes (or different sub-processes, e.g. in MIMO with different beams/layers associated to the same process identifier, but different sub-process-identifiers like swap bits). A scheduling assignment and/or a HARQ codebook may indicate a target HARQ structure. A target HARQ structure may for example indicate an intended HARQ response to a subject transmission, e.g. the number of bits and/or whether to provide code block group level response or not. However, it should be noted that the actual structure used may differ from the target structure, e.g. due to the total size of target structures for a subpattern being larger than the predetermined size.

Transmitting acknowledgement signalling, also referred to as transmitting acknowledgement information or feedback information or simply as ARQ or HARQ feedback or feedback or reporting feedback, may comprise, and/or be based on determining correct or incorrect reception of subject transmission/s, e.g. based on error coding and/or based on scheduling assignment/s scheduling the subject transmissions. Transmitting acknowledgement information may be based on, and/or comprise, a structure for acknowledgement information to transmit, e.g. the structure of one or more subpatterns, e.g. based on which subject transmission is scheduled for an associated subdivision. Transmitting acknowledgement information may comprise transmitting corresponding signalling, e.g. at one instance and/or in one message and/or one channel, in particular a physical channel, which may be a control channel. In some cases, the channel may be a shared channel or data channel, e.g. utilising rate-matching of the acknowledgment information. The acknowledgement information may generally pertain to a plurality of subject transmissions, which may be on different channels and/or carriers, and/or may comprise data signalling and/or control signalling. The acknowledgment information may be based on a codebook, which may be based on one or more size indications and/or assignment indications (representing HARQ structures), which may be received with a plurality of control signallings and/or control messages e.g. in the same or different transmission timing structures, and/or in the same or different (target) sets of resources. Transmitting acknowledgement information may comprise determining the codebook, e.g. based on control information in one or more control information messages and/or a configuration. A codebook may pertain to transmitting acknowledgement information at a single and/or specific instant, e.g. a single PUCCH or PUSCH transmission, and/or in one message or with jointly encoded and/or modulated acknowledgement information. Generally, acknowledgment information may be transmitted together with other control information, e.g. a scheduling request and/or measurement information.

Acknowledgement signalling may in some cases comprise, next to acknowledgement in-formation, other information, e.g. control information, in particular, uplink or sidelink control information, like a scheduling request and/or measurement information, or similar, and/or error detection and/or correction information, respectively associated bits. The payload size of acknowledgement signalling may represent the number of bits of acknowledgement information, and/or in some cases the total number of bits carried by the acknowledgement signalling, and/or the number of resource elements needed. Acknowledgement signalling and/or information may pertain to ARQ and/or HARQ processes; an ARQ process may provide ACK/NACK (and perhaps additional feedback) feedback, and decoding may be performed on each (re-)transmission separately, without soft-buffering/soft-combining intermediate data, whereas HARQ may comprise soft-buffering/soft-combining of intermediate data of decoding for one or more (re-)transmissions.

Subject transmission may be data signalling or control signalling. The transmission may be on a shared or dedicated channel. Data signalling may be on a data channel, for example on a PDSCH or PSSCH, or on a dedicated data channel, e.g. for low latency and/or high reliability, e.g. a URLLC channel. Control signalling may be on a control channel, for example on a common control channel or a PDCCH or PSCCH, and/or comprise one or more DCI messages or SCI messages. In some cases, the subject transmission may comprise, or represent, reference signalling. For example, it may comprise DM-RS and/or pilot signalling and/or discovery signalling and/or sounding signalling and/or phase tracking signalling and/or cell-specific reference signalling and/or user-specific signalling, in particular CSI-RS. A subject transmission may pertain to one scheduling assignment and/or one acknowledgement signalling process (e.g., according to identifier or subidentifier), and/or one subdivision. In some cases, a subject transmission may cross the borders of subdivisions in time, e.g. due to being scheduled to start in one subdivision and extending into another, or even crossing over more than one subdivision. In this case, it may be considered that the subject transmission is associated to the subdivision it ends in.

It may be considered that transmitting acknowledgement information, in particular of acknowledgement information, is based on determining whether the subject transmission/s has or have been received correctly, e.g. based on error coding and/or reception quality. Reception quality may for example be based on a determined signal quality. Acknowledgement information may generally be transmitted to a signalling radio node and/or node arrangement and/or to a network and/or network node.

Acknowledgement information, or bit/s of a subpattern structure of such information (e.g., an acknowledgement information structure, may represent and/or comprise one or more bits, in particular a pattern of bits. Multiple bits pertaining to a data structure or substructure or message like a control message may be considered a subpattern. The structure or arrangement of acknowledgement information may indicate the order, and/or meaning, and/or mapping, and/or pattern of bits (or subpatterns of bits) of the information. The structure or mapping may in particular indicate one or more data block structures, e.g. code blocks and/or code block groups and/or transport blocks and/or messages, e.g. command messages, the acknowledgement information pertains to, and/or which bits or subpattern of bits are associated to which data block structure. In some cases, the mapping may pertain to one or more acknowledgement signalling processes, e.g. processes with different identifiers, and/or one or more different data streams. The configuration or structure or codebook may indicate to which process/es and/or data stream/s the information pertains. Generally, the acknowledgement information may comprise one or more subpatterns, each of which may pertain to a data block structure, e.g. a code block or code block group or transport block. A subpattern may be arranged to indicate acknowledgement or non-acknowledgement, or another retransmission state like non-scheduling or non-reception, of the associated data block structure. It may be considered that a subpattern comprises one bit, or in some cases more than one bit. It should be noted that acknowledgement information may be subjected to significant processing before being transmitted with acknowledgement signalling. Different configurations may indicate different sizes and/or mapping and/or structures and/or pattern.

An acknowledgment signalling process (providing acknowledgment information) may be a HARQ process, and/or be identified by a process identifier, e.g. a HARQ process identifier or sub-identifier. Acknowledgement signalling and/or associated acknowledgement information may be referred to as feedback or acknowledgement feedback. It should be noted that data blocks or structures to which subpatterns may pertain may be intended to carry data (e.g., information and/or systemic and/or coding bits). However, depending on transmission conditions, such data may be received or not received (or not received correctly), which may be indicated correspondingly in the feedback. In some cases, a subpattern of acknowledgement signalling may comprise padding bits, e.g. if the acknowledgement information for a data block requires fewer bits than indicated as size of the subpattern. Such may for example happen if the size is indicated by a unit size larger than required for the feedback.

Acknowledgment information may generally indicate at least ACK or NACK, e.g. pertaining to an acknowledgment signalling process, or an element of a data block structure like a data block, subblock group or subblock, or a message, in particular a control message. Generally, to an acknowledgment signalling process there may be associated one specific subpattern and/or a data block structure, for which acknowledgment information may be provided. Acknowledgement information may comprise a plurality of pieces of information, represented in a plurality of ARQ and/or HARQ structures.

An acknowledgment signalling process may determine correct or incorrect reception, and/or corresponding acknowledgement information, of a data block like a transport block, and/or substructures thereof, based on coding bits associated to the data block, and/or based on coding bits associated to one or more data block and/or subblocks and/or subblock group/s. Acknowledgement information (determined by an acknowledgement signalling process) may pertain to the data block as a whole, and/or to one or more subblocks or subblock groups. A code block may be considered an example of a subblock, whereas a code block group may be considered an example of a subblock group. Accordingly, the associated subpattern may comprise one or more bits indicating reception status or feedback of the data block, and/or one or more bits indicating reception status or feedback of one or more subblocks or subblock groups. Each subpattern or bit of the subpattern may be associated and/or mapped to a specific data block or subblock or subblock group. In some variants, correct reception for a data block may be indicated if all subblocks or subblock groups are correctly identified. In such a case, the subpattern may represent acknowledgement information for the data block as a whole, reducing overhead in comparison to provide acknowledgement information for the subblocks or subblock groups. The smallest structure (e.g. subblock/subblock group/data block) the subpattern provides acknowledgement information for and/or is associated to may be considered its (highest) resolution. In some variants, a subpattern may provide acknowledgment information regarding several elements of a data block structure and/or at different resolution, e.g. to allow more specific error detection. For example, even if a subpattern indicates acknowledgment signalling pertaining to a data block as a whole, in some variants higher resolution (e.g., subblock or subblock group resolution) may be provided by the subpattern. A subpattern may generally comprise one or more bits indicating ACK/NACK for a data block, and/or one or more bits for indicating ACK/NACK for a subblock or subblock group, or for more than one subblock or subblock group.

A subblock and/or subblock group may comprise information bits (representing the data to be transmitted, e.g. user data and/or downlink/sidelink data or uplink data). It may be considered that a data block and/or subblock and/or subblock group also comprises error one or more error detection bits, which may pertain to, and/or be determined based on, the information bits (for a subblock group, the error detection bit/s may be determined based on the information bits and/or error detection bits and/or error correction bits of the subblock/s of the subblock group). A data block or substructure like subblock or subblock group may comprise error correction bits, which may in particular be determined based on the information bits and error detection bits of the block or substructure, e.g. utilising an error correction coding scheme, in particular for forward error correction (FEC), e.g. LDPC or polar coding and/or turbo coding. Generally, the error correction coding of a data block structure (and/or associated bits) may cover and/or pertain to information bits and error detection bits of the structure. A subblock group may represent a combination of one or more code blocks, respectively the corresponding bits. A data block may represent a code block or code block group, or a combination of more than one code block groups. A transport block may be split up in code blocks and/or code block groups, for example based on the bit size of the information bits of a higher layer data structure provided for error coding and/or size requirements or preferences for error coding, in particular error correction coding. Such a higher layer data structure is sometimes also referred to as transport block, which in this context represents information bits without the error coding bits described herein, although higher layer error handling information may be included, e.g. for an internet protocol like TCP. However, such error handling information represents information bits in the context of this disclosure, as the acknowledgement signalling procedures described treat it accordingly.

In some variants, a subblock like a code block may comprise error correction bits, which may be determined based on the information bit/s and/or error detection bit/s of the subblock. An error correction coding scheme may be used for determining the error correction bits, e.g. based on LDPC or polar coding or Reed-Mueller coding. In some cases, a subblock or code block may be considered to be defined as a block or pattern of bits comprising information bits, error detection bit/s determined based on the information bits, and error correction bit/s determined based on the information bits and/or error detection bit/s. It may be considered that in a subblock, e.g. code block, the information bits (and possibly the error correction bit/s) are protected and/or covered by the error correction scheme or corresponding error correction bit/s. A code block group may comprise one or more code blocks. In some variants, no additional error detection bits and/or error correction bits are applied, however, it may be considered to apply either or both. A transport block may comprise one or more code block groups. It may be considered that no additional error detection bits and/or error correction bits are applied to a transport block, however, it may be considered to apply either or both. In some specific variants, the code block group/s comprise no additional layers of error detection or correction coding, and the transport block may comprise only additional error detection coding bits, but no additional error correction coding. This may particularly be true if the transport block size is larger than the code block size and/or the maximum size for error correction coding. A subpattern of acknowledgement signalling (in particular indicating ACK or NACK) may pertain to a code block, e.g. indicating whether the code block has been correctly received. It may be considered that a subpattern pertains to a subgroup like a code block group or a data block like a transport block. In such cases, it may indicate ACK, if all subblocks or code blocks of the group or data/transport block are received correctly (e.g. based on a logical AND operation), and NACK or another state of non-correct reception if at least one subblock or code block has not been correctly received. It should be noted that a code block may be considered to be correctly received not only if it actually has been correctly received, but also if it can be correctly reconstructed based on soft-combining and/or the error correction coding.

A subpattern/HARQ structure may pertain to one acknowledgement signalling process and/or one carrier like a component carrier and/or data block structure or data block. It may in particular be considered that one (e.g. specific and/or single) subpattern pertains, e.g. is mapped by the codebook, to one (e.g., specific and/or single) acknowledgement signalling process, e.g. a specific and/or single HARQ process. It may be considered that in the bit pattern, subpatterns are mapped to acknowledgement signalling processes and/or data blocks or data block structures on a one-to-one basis. In some variants, there may be multiple subpatterns (and/or associated acknowledgment signalling processes) associated to the same component carrier, e.g. if multiple data streams transmitted on the carrier are subject to acknowledgement signalling processes. A subpattern may comprise one or more bits, the number of which may be considered to represent its size or bit size. Different bit n-tuples (n being 1 or larger) of a subpattern may be associated to different elements of a data block structure (e.g., data block or subblock or subblock group), and/or represent different resolutions. There may be considered variants in which only one resolution is represented by a bit pattern, e.g. a data block. A bit n-tuple may represent acknowledgement information (also referred to a feedback), in particular ACK or NACK, and optionally, (if n¿1), may represent DTX/DRX or other reception states. ACK/NACK may be represented by one bit, or by more than one bit, e.g. to improve disambiguity of bit sequences representing ACK or NACK, and/or to improve transmission reliability.

The acknowledgement information or feedback information may pertain to a plurality of different transmissions, which may be associated to and/or represented by data block structures, respectively the associated data blocks or data signalling. The data block structures, and/or the corresponding blocks and/or signalling, may be scheduled for simultaneous transmission, e.g. for the same transmission timing structure, in particular within the same slot or subframe, and/or on the same symbol/s. However, alternatives with scheduling for non-simultaneous transmission may be considered. For example, the acknowledgment information may pertain to data blocks scheduled for different transmission timing structures, e.g. different slots (or mini-slots, or slots and mini-slots) or similar, which may correspondingly be received (or not or wrongly received). Scheduling signalling may generally comprise indicating resources, e.g. time and/or frequency resources, for example for receiving or transmitting the scheduled signalling.

signalling may generally be considered to represent an electromagnetic wave structure (e.g., over a time interval and frequency interval), which is intended to convey information to at least one specific or generic (e.g., anyone who might pick up the signalling) target. A process of signalling may comprise transmitting the signalling. Transmitting signalling, in particular control signalling or communication signalling, e.g. comprising or representing acknowledgement signalling and/or resource requesting information, may comprise encoding and/or modulating. Encoding and/or modulating may comprise error detection coding and/or forward error correction encoding and/or scrambling. Receiving control signalling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to. A code rate may represent the ratio of the number of information bits before encoding to the number of encoded bits after encoding, considering that encoding adds coding bits for error detection coding and forward error correction. Coded bits may refer to information bits (also called systematic bits) plus coding bits.

Communication signalling may comprise, and/or represent, and/or be implemented as, data signalling, and/or user plane signalling. Communication signalling may be associated to a data channel, e.g. a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signalling may be signalling associated to and/or on a data channel.

An indication generally may explicitly and/or implicitly indicate the information it represents and/or indicates. Implicit indication may for example be based on position and/or resource used for transmission. Explicit indication may for example be based on a parametrisation with one or more parameters, and/or one or more index or indices, and/or one or more bit patterns representing the information. It may in particular be considered that control signalling as described herein, based on the utilised resource sequence, implicitly indicates the control signalling type.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception. In some variants, a signal (jointly encoded/modulated) may cover more than one resource elements. A resource element may generally be as defined by a corresponding standard, e.g. NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signalling, e.g. according to a specific format, may be communicated, for example transmitted and/or received, and/or be intended for transmission and/or reception.

A border symbol may generally represent a starting symbol or an ending symbol for transmitting and/or receiving. A starting symbol may in particular be a starting symbol of uplink or sidelink signalling, for example control signalling or data signalling. Such signalling may be on a data channel or control channel, e.g. a physical channel, in particular a physical uplink shared channel (like PUSCH) or a sidelink data or shared channel, or a physical uplink control channel (like PUCCH) or a sidelink control channel. If the starting symbol is associated to control signalling (e.g., on a control channel), the control signalling may be in response to received signalling (in sidelink or downlink), e.g. representing acknowledgement signalling associated thereto, which may be HARQ or ARQ signalling. An ending symbol may represent an ending symbol (in time) of downlink or sidelink transmission or signalling, which may be intended or scheduled for the radio node or user equipment. Such downlink signalling may in particular be data signalling, e.g. on a physical downlink channel like a shared channel, e.g. a PDSCH (Physical Downlink Shared Channel). A starting symbol may be determined based on, and/or in relation to, such an ending symbol.

Configuring a radio node, in particular a terminal or user equipment, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilise, and/or be adapted to utilise, its circuitry/ies for configuring. Allocation information may be considered a form of configuration data. Configuration data may comprise and/or be represented by configuration information, and/or one or more corresponding indications and/or message/s

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal may comprise scheduling downlink and/or uplink transmissions for the terminal, e.g. downlink data and/or downlink control signalling and/or DCI and/or uplink control or data or communication signalling, in particular acknowledgement signalling, and/or configuring resources and/or a resource pool therefor.

A resource structure may be considered to be neighboured in frequency domain by another resource structure, if they share a common border frequency, e.g. one as an upper frequency border and the other as a lower frequency border. Such a border may for example be represented by the upper end of a bandwidth assigned to a subcarrier n, which also represents the lower end of a bandwidth assigned to a subcarrier n+1. A resource structure may be considered to be neighboured in time domain by another resource structure, if they share a common border time, e.g. one as an upper (or right in the figures) border and the other as a lower (or left in the figures) border. Such a border may for example be represented by the end of the symbol time interval assigned to a symbol n, which also represents the beginning of a symbol time interval assigned to a symbol n+1.

Generally, a resource structure being neighboured by another resource structure in a domain may also be referred to as abutting and/or bordering the other resource structure in the domain.

A resource structure may general represent a structure in time and/or frequency domain, in particular representing a time interval and a frequency interval. A resource structure may comprise and/or be comprised of resource elements, and/or the time interval of a resource structure may comprise and/or be comprised of symbol time interval/s, and/or the frequency interval of a resource structure may comprise and/or be comprised of sub-carrier/s. A resource element may be considered an example for a resource structure, a slot or mini-slot or a Physical Resource Block (PRB) or parts thereof may be considered others. A resource structure may be associated to a specific channel, e.g. a PUSCH or PUCCH, in particular resource structure smaller than a slot or PRB.

Examples of a resource structure in frequency domain comprise a bandwidth or band, or a bandwidth part. A bandwidth part may be a part of a bandwidth available for a radio node for communicating, e.g. due to circuitry and/or configuration and/or regulations and/or a standard. A bandwidth part may be configured or configurable to a radio node. In some variants, a bandwidth part may be the part of a bandwidth used for communicating, e.g. transmitting and/or receiving, by a radio node. The bandwidth part may be smaller than the bandwidth (which may be a device bandwidth defined by the circuitry/configuration of a device, and/or a system bandwidth, e.g. available for a RAN). It may be considered that a bandwidth part comprises one or more resource blocks or resource block groups, in particular one or more PRBs or PRB groups. A bandwidth part may pertain to, and/or comprise, one or more carriers.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g. represented by one or more subcarriers (to each subcarrier there may be generally assigned a frequency bandwidth or interval). Different carriers may be non-overlapping, and/or may be neighbouring in frequency domain.

It should be noted that the term “radio” in this disclosure may be considered to pertain to wireless communication in general, and may also include wireless communication utilising millimeter waves, in particular above one of the thresholds 10 GHz or 20 GHz or 50 GHz or 52 GHz or 52.6 GHz or 60 GHz or 72 GHz or 100 GHz or 114 GHz. Such communication may utilise one or more carriers, e.g. in FDD and/or carrier aggregation. Upper frequency boundaries may correspond to 300 GHz or 200 GHz or 120 GHz or any of the thresholds larger than the one representing the lower frequency boundary.

A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on an LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

A channel may generally be a logical, transport or physical channel. A channel may comprise and/or be arranged on one or more carriers, in particular a plurality of subcarriers. A channel carrying and/or for carrying control signalling/control information may be considered a control channel, in particular if it is a physical layer channel and/or if it carries control plane information. Analogously, a channel carrying and/or for carrying data signalling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have two component channels, one for each direction. Examples of channels comprise a channel for low latency and/or high reliability transmission, in particular a channel for Ultra-Reliable Low Latency Communication (URLLC), which may be for control and/or data.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of, or associated to, a symbol. Accordingly, different symbols may have different symbol time lengths. In parti-lar, numerologies with different subcarrier spacings may have different symbol time length. Generally, a symbol time length may be based on, and/or include, a guard time interval or cyclic extension, e.g. prefix or postfix.

A sidelink may generally represent a communication channel (or channel structure) between two UEs and/or terminals, in which data is transmitted between the participants (UEs and/or terminals) via the communication channel, e.g. directly and/or without being relayed via a network node. A sidelink may be established only and/or directly via air interface/s of the participant, which may be directly linked via the sidelink communication channel. In some variants, sidelink communication may be performed without interaction by a network node, e.g. on fixedly defined resources and/or on resources negotiated between the participants. Alternatively, or additionally, it may be considered that a network node provides some control functionality, e.g. by configuring resources, in particular one or more resource pool/s, for sidelink communication, and/or monitoring a sidelink, e.g. for charging purposes.

Sidelink communication may also be referred to as device-to-device (D2D) communication, and/or in some cases as ProSe (Proximity Services) communication, e.g. in the context of LTE. A sidelink may be implemented in the context of V2x communication (Vehicular communication), e.g. V2V (Vehicle-to-Vehicle), V2I (Vehicle-to-Infrastructure) and/or V2P (Vehicle-to-Person). Any device adapted for sidelink communication may be considered a user equipment or terminal.

A sidelink communication channel (or structure) may comprise one or more (e.g., physical or logical) channels, e.g. a PSCCH (Physical Sidelink Control CHannel, which may for example carry control information like an acknowledgement position indication, and/or a PSSCH (Physical Sidelink Shared CHannel, which for example may carry data and/or acknowledgement signalling). It may be considered that a sidelink communication channel (or structure) pertains to and/or used one or more carrier/s and/or frequency range/s associated to, and/or being used by, cellular communication, e.g. according to a specific license and/or standard. Participants may share a (physical) channel and/or resources, in particular in frequency domain and/or related to a frequency resource like a carrier) of a sidelink, such that two or more participants transmit thereon, e.g. simultaneously, and/or time-shifted, and/or there may be associated specific channels and/or resources to specific participants, so that for example only one participant transmits on a specific channel or on a specific resource or specific resources, e.g., in frequency domain and/or related to one or more carriers or subcarriers.

A sidelink may comply with, and/or be implemented according to, a specific standard, e.g. an LTE-based standard and/or NR. A sidelink may utilise TDD (Time Division Duplex) and/or FDD (Frequency Division Duplex) technology, e.g. as configured by a network node, and/or preconfigured and/or negotiated between the participants. A user equipment may be considered to be adapted for sidelink communication if it, and/or its radio circuitry and/or processing circuitry, is adapted for utilising a sidelink, e.g. on one or more frequency ranges and/or carriers and/or in one or more formats, in particular according to a specific standard. It may be generally considered that a Radio Access Network is defined by two participants of a sidelink communication. Alternatively, or additionally, a Radio Access Network may be represented, and/or defined with, and/or be related to a network node and/or communication with such a node.

Communication or communicating may generally comprise transmitting and/or receiving signalling. Communication on a sidelink (or sidelink signalling) may comprise utilising the sidelink for communication (respectively, for signalling). Sidelink transmission and/or transmitting on a sidelink may be considered to comprise transmission utilising the sidelink, e.g. associated resources and/or transmission formats and/or circuitry and/or the air interface. Sidelink reception and/or receiving on a sidelink may be considered to comprise reception utilising the sidelink, e.g. associated resources and/or transmission formats and/or circuitry and/or the air interface. Sidelink control information (e.g., SCI) may generally be considered to comprise control information transmitted utilising a sidelink.

Generally, carrier aggregation (CA) may refer to the concept of a radio connection and/or communication link between a wireless and/or cellular communication network and/or network node and a terminal or on a sidelink comprising a plurality of carriers for at least one direction of transmission (e.g. DL and/or UL), as well as to the aggregate of carriers. A corresponding communication link may be referred to as carrier aggregated communication link or CA communication link; carriers in a carrier aggregate may be referred to as component carriers (CC). In such a link, data may be transmitted over more than one of the carriers and/or all the carriers of the carrier aggregation (the aggregate of carriers). A carrier aggregation may comprise one (or more) dedicated control carriers and/or primary carriers (which may e.g. be referred to as primary component carrier or PCC), over which control information may be transmitted, wherein the control information may refer to the primary carrier and other carriers, which may be referred to as secondary carriers (or secondary component carrier, SCC). However, in some approaches, control information may be sent over more than one carrier of an aggregate, e.g. one or more PCCs and one PCC and one or more SCCs.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

A configuration or schedule, like a mini-slot configuration and/or structure configuration, may schedule transmissions, e.g. for the time/transmissions it is valid, and/or transmissions may be scheduled by separate signalling or separate configuration, e.g. separate RRC signalling and/or downlink control information signalling. The transmission/s scheduled may represent signalling to be transmitted by the device for which it is scheduled, or signalling to be received by the device for which it is scheduled, depending on which side of a communication the device is. It should be noted that downlink control information or specifically DCI signalling may be considered physical layer signalling, in contrast to higher layer signalling like MAC (Medium Access Control) signalling or RRC layer signalling. The higher the layer of signalling is, the less frequent/the more time/resource consuming it may be considered, at least partially due to the information contained in such signalling having to be passed on through several layers, each layer requiring processing and handling.

A scheduled transmission, and/or transmission timing structure like a mini-slot or slot, may pertain to a specific channel, in particular a physical uplink shared channel, a physical uplink control channel, or a physical downlink shared channel, e.g. PUSCH, PUCCH or PDSCH, and/or may pertain to a specific cell and/or carrier aggregation. A corresponding configuration, e.g. scheduling configuration or symbol configuration may pertain to such channel, cell and/or carrier aggregation. It may be considered that the scheduled transmission represents transmission on a physical channel, in particular a shared physical channel, for example a physical uplink shared channel or physical downlink shared channel. For such channels, semi-persistent configuring may be particularly suitable.

Generally, a configuration may be a configuration indicating timing, and/or be represented or configured with corresponding configuration data. A configuration may be embedded in, and/or comprised in, a message or configuration or corresponding data, which may indicate and/or schedule resources, in particular semi-persistently and/or semi-statically.

A control region of a transmission timing structure may be an interval in time and/or frequency domain for intended or scheduled or reserved for control signalling, in particular downlink control signalling, and/or for a specific control channel, e.g. a physical downlink control channel like PDCCH. The interval may comprise, and/or consist of, a number of symbols in time, which may be configured or configurable, e.g. by (UE-specific) dedicated signalling (which may be single-cast, for example addressed to or intended for a specific UE), e.g. on a PDCCH, or RRC signalling, or on a multicast or broadcast channel. In general, the transmission timing structure may comprise a control region covering a configurable number of symbols. It may be considered that in general the border symbol is configured to be after the control region in time. A control region may be associated, e.g. via configuration and/or determination, to one or more specific UEs and/or formats of PDCCH and/or DCI and/or identifiers, e.g. UE identifiers and/or RNTIs or carrier/cell identifiers, and/or be represented and/or associated to a CORESET and/or a search space.

The duration of a symbol (symbol time length or interval) of the transmission timing structure may generally be dependent on a numerology and/or carrier, wherein the numerology and/or carrier may be configurable. The numerology may be the numerology to be used for the scheduled transmission.

System information signalling may comprise and/or represent signalling indicating one or more system parameters, in particular timing and/or synchronisation, and/or numerology and/or a system identity (e.g. beam identity and/or cell ID and/or node ID and/or network ID). System information signalling may comprise broadcast signalling or multicast signalling; it may be beam-formed signalling, or non-beam-formed. In some cases, system information signalling may comprise synchronisation signalling, e.g. PSS and/or SSS, and/or reference signalling, e.g. DM-RS, and/or data signalling, e.g. on a broadcast channel like PBCH, or on a data channel like PDSCH, e.g. suitable for broadcast or multicast, or scrambled with an ID provided in earlier signalling or predefined in a standard. Such data signalling may comprise encoded information, e.g. with error detection coding and/or error correction coding. System information signalling may comprise System Information, e.g. a Master Information Block (MIB) and/or one or more System Information Blocks (SIB). System information signalling may be carried on a SSB beam.

A transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signalling is received, e.g. in relation to the timing grid. A transmission timing structure may in particular be a slot or subframe or in some cases, a mini-slot.

Feedback signalling may be considered a form or control signalling, e.g. uplink or sidelink control signalling, like UCI (Uplink Control Information) signalling or SCI (Sidelink Control Information) signalling. Feedback signalling may in particular comprise and/or represent acknowledgement signalling and/or acknowledgement information and/or measurement reporting.

Signalling utilising, and/or on and/or associated to, resources or a resource structure may be signalling covering the resources or structure, signalling on the associated frequency/ies and/or in the associated time interval/s. It may be considered that a signalling resource structure comprises and/or encompasses one or more substructures, which may be associated to one or more different channels and/or types of signalling and/or comprise one or more holes (resource element/s not scheduled for transmissions or reception of transmissions). A resource substructure, e.g. a feedback resource structure, may generally be continuous in time and/or frequency, within the associated intervals. It may be considered that a substructure, in particular a feedback resource structure, represents a rectangle filled with one or more resource elements in time/frequency space. However, in some cases, a resource structure or substructure, in particular a frequency resource range, may represent a non-continuous pattern of resources in one or more domains, e.g. time and/or frequency. The resource elements of a substructure may be scheduled for associated signalling.

Example types of signalling comprise signalling of a specific communication direction, in particular, uplink signalling, downlink signalling, sidelink signalling, as well as reference signalling (e.g., SRS or CRS or CSI-RS), communication signalling, control signalling, and/or signalling associated to a specific channel like PUSCH, PDSCH, PUCCH, PDCCH, PSCCH, PSSCH, etc.).

In the context of this disclosure, there may be distinguished between dynamically scheduled or aperiodic transmission and/or configuration, and semi-static or semi-persistent or periodic transmission and/or configuration. The term “dynamic” or similar terms may generally pertain to configuration/transmission valid and/or scheduled and/or configured for (relatively) short timescales and/or a (e.g., predefined and/or configured and/or limited and/or definite) number of occurrences and/or transmission timing structures, e.g. one or more transmission timing structures like slots or slot aggregations, and/or for one or more (e.g., specific number) of transmission/occurrences. Dynamic configuration may be based on low-level signalling, e.g. control signalling on the physical layer and/or MAC layer, in particular in the form of DCI or SCI. Periodic/semi-static may pertain to longer timescales, e.g. several slots and/or more than one frame, and/or a non-defined number of occurrences, e.g., until a dynamic configuration contradicts, or until a new periodic configuration arrives. A periodic or semi-static configuration may be based on, and/or be configured with, higher-layer signalling, in particular RCL layer signalling and/or RRC signalling and/or MAC signalling.

In this disclosure, for purposes of explanation and not limitation, specific details are set forth (such as particular network functions, processes and signalling steps) in order to provide a thorough understanding of the technique presented herein. It will be apparent to one skilled in the art that the present concepts and aspects may be practised in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM) or IEEE standards as IEEE 802.11ad or IEEE 802.11 ay. While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

Some useful abbreviations comprise

| Abbreviation | Explanation |
|---|---|
| ABF | Analog beamformer, fanout to antenna + beamforming |
| ACK/NACK | Acknowledgment/Negative Acknowledgement |
| Ant | Antenna |
| ARQ | Automatic Repeat reQuest |
| BB | BaseBand |
| Beamindex | beamindex interface |
| IF | |
| BER | Bit Error Rate |
| BI | Beam Index |
| BLER | Block Error Rate |
| BPSK | Binary Phase Shift Keying |
| BWP | BandWidth Part |
| CAZAC | Constant Amplitude Zero Cross Correlation |
| CB | Code Block |
| CBB | Code Block Bundle |
| CBG | Code Block Group |
| CDM | Code Division Multiplex |
| CM | Cubic Metric |
| Comm RXBB | communication receiver baseband |
| CORESET | Control Resource Set |
| CP | Cyclic Prefix |
| CP rem | CP removal |
| CQI | Channel Quality Information |
| CRC | Cyclic Redundancy Check |
| CRS | Common reference signal |
| CSI | Channel State Information |
| CSI-RS | Channel state information reference signal |
| DAI | Downlink Assignment Indicator |
| DCI | Downlink Control Information |
| DFE | Digital Frontend |
| DFT | Discrete Fourier Transform |
| DFTS-FDM | DFT-spread-FDM |
| DM(-)RS | Demodulation reference signal(ing) |
| eMBB | enhanced Mobile BroadBand |
| FDD | Frequency Division Duplex |
| FDE | Frequency Domain Equalisation |
| FDF | Frequency Domain Filtering |
| FDM | Frequency Division Multiplex |
| FFT | Fast Fourier Transform |
| GPIO | General Purpose Input Output |
| HARQ | Hybrid Automatic Repeat Request |
| IAB | Integrated Access and Backhaul |
| IFFT | Inverse Fast Fourier Transform |
| Im | Imaginary part, e.g. for pi/2*BPSK modulation |
| IR | Impulse Response |
| ISI | Inter Symbol Interference |
| JCAS | Joint Communication and Sensing |
| MBB | Mobile Broadband |
| MCS | Modulation and Coding Scheme |
| MIMO | Multiple-input-multiple-output |
| MRC | Maximum-ratio combining |
| MRT | Maximum-ratio transmission |
| MU-MIMO | Multiuser multiple-input-multiple-output |
| OFDM/A | Orthogonal Frequency Division Multiplex/Multiple |
| | Access |
| PAPR | Peak to Average Power Ratio |
| PDCCH | Physical Downlink Control Channel |
| PDSCH | Physical Downlink Shared Channel |
| PRACH | Physical Random Access CHannel |
| PRB | Physical Resource Block |
| PUCCH | Physical Uplink Control Channel |
| PUSCH | Physical Uplink Shared Channel |
| (P)SCCH | (Physical) Sidelink Control Channel |
| PSS | Primary Synchronisation Signal(ing) |
| PT-RS | Phase Tracking Reference signalling |
| (P)SSCH | (Physical) Sidelink Shared Channel |
| QAM | Quadrature Amplitude Modulation |
| OCC | Orthogonal Cover Code |
| QPSK | Quadrature Phase Shift Keying |
| PSD | Power Spectral Density |
| RAN | Radio Access Network |
| RAT | Radio Access Technology |
| RB | Resource Block |
| RE | Resource Element |
| Re | Real part (e.g., for pi/2*BPSK) modulation |
| RF | Radio Frequency |
| RNTI | Radio Network Temporary Identifier |
| RRC | Radio Resource Control |
| RX | Receiver, Reception, Reception-related/side |
| SA | Scheduling Assignment |
| SC-FDE | Single Carrier Frequency Domain Equalisation |
| SC-FDM/A | Single Carrier Frequency Division Multiplex/Multiple |
| | Access |
| SCI | Sidelink Control Information |
| SINR | Signal-to-interference-plus-noise ratio |
| SIR | Signal-to-interference ratio |
| SNR | Signal-to-noise-ratio |
| SPI | Serial to Parallel Interface |
| SR | Scheduling Request |
| SRS | Sounding Reference Signal(ing) |
| SSS | Secondary Synchronisation Signal(ing) |
| SVD | Singular-value decomposition |
| TB | Transport Block |
| TDD | Time Division Duplex |
| TDM | Time Division Multiplex |
| T-RS | Tracking Reference signalling or Timing Reference |
| | signalling |
| TX | Transmitter, Transmission, Transmission-related/side |
| UCI | Uplink Control Information |
| UDC | Up-Down Converter, mixing from BB [symbol] -¿RF |
| UE | User Equipment |
| URLLC | Ultra Low Latency High Reliability Communication |
| VL-MIMO | Very-large multiple-input-multiple-output |
| WD | Wireless Device |
| Wfg | Waveform Generator |
| ZC | Zadoff-Chu |
| ZF | Zero Forcing |
| ZP | Zero-Power, e.g. muted CSI-RS symbol |

Abbreviations may be considered to follow 3GPP usage if applicable.

1. A method of operating a receiving radio node in a radio access network, the method comprising communicating based on a received random access response, the random access response having multiple symbol contents, the random access response having a signalling structure in which for each symbol content, the symbol content is repeated sequentially NO-times, wherein NO is an integer of 2 or larger.

2. A receiving radio node for a radio access network, the receiving radio node being adapted for communicating based on a received random access response, the random access response having multiple symbol contents, the random access response having a signalling structure in which for each symbol content, the symbol content is repeated sequentially NO-times, wherein NO is an integer of 2 or larger.

3. A method of operating a transmitting radio node in radio access network, the method comprising transmitting a random access response, the random access response having multiple symbol contents, the random access response having a signalling structure in which for each symbol content, the symbol content is repeated sequentially NO-times, wherein NO is an integer of 2 or larger.

4. (canceled)

5. The method of claim 1, wherein in the signalling structure, a cyclic prefix precedes each repetition sequence of the symbol content.

6. The method of claim 1, wherein the receiving radio node is adapted to operate according to a transmission timing structure, wherein in the signalling structure, at least one repetition of the symbol content is not aligned with the transmission timing structure.

7. The method of claim 1, wherein the multiple symbol contents comprise encoded information.

8. The method of claim 1, wherein each of the multiple symbol contents are different.

9. The method of claim 1, wherein the symbol contents comprise, and/or at least one symbol content comprises, reference signalling.

10. The method of claim 1, wherein each symbol content repetition is carried on one allocation unit.

11. The method of claim 1, wherein at least one symbol content comprises Demodulation Reference Signalling, DM-RS, and also comprises control information.

12. The method of claim 1, wherein at least one symbol content comprises Demodulation Reference Signalling on a comb in frequency domain.

13-14. (canceled)

15. The method of claim 9, wherein the reference signalling is demodulation reference signalling, DM-RS.

16. The method of claim 10, wherein the allocation unit is a block symbol or a symbol time interval.

17. The method of claim 11, wherein the control information is encoded control information.

18. The receiving radio node of claim 2, wherein in the signalling structure, a cyclic prefix precedes each repetition sequence of the symbol content.

19. The receiving radio node of claim 2, wherein the receiving radio node is adapted to operate according to a transmission timing structure, wherein in the signalling structure, at least one repetition of the symbol content is not aligned with the transmission timing structure.

20. The receiving radio node of claim 2, wherein the multiple symbol contents comprise encoded information.

21. The method of claim 3, wherein in the signalling structure, a cyclic prefix precedes each repetition sequence of the symbol content.

22. The method of claim 3, wherein the multiple symbol contents comprise encoded information.

23. The method of claim 3, wherein each of the multiple symbol contents are different.
